(19) United States
(12) Patent Application Publication
(10) Pub. No.: US 2025/0118768 A1
(43) Pub. Date: Apr. 10, 2025

(54) RECHARGEABLE ZINC-NITRATE/ETHANOL BATTERY

(71) Applicant: City University of Hong Kong, Hong Kong (HK)

(72) Inventors: Zhanxi FAN, Hong Kong (HK); Jingwen ZHOU, Hong Kong (HK); Yuecheng XIONG, Hong Kong (HK)

(21) Appl. No.: 18/666,870

(22) Filed: May 17, 2024

Related U.S. Application Data
(60) Provisional application No. 63/588,295, filed on Oct. 6, 2023.

(51) Int. Cl. H01M 4/92; C01G 55/00; H01M 4/86; H01M 8/08; H01M 8/18

(52) U.S. Cl. CPC H01M 4/921; C01G 55/00; H01M 4/926; H01M 8/08; H01M 8/188; C01P 2006/40; H01M 2004/8689; H01M 2300/0002

(57) ABSTRACT

The present invention pertains to a method for preparing ultra-thin RhCu nanostructures modified with M-TPP and applications thereof. By adjusting the feeding ratio of raw materials, the morphology, composition, purity, and size of RhCu M-tpp can be customized. The simplicity of operation and the robustness of reaction parameters contribute to high reproducibility of the target products. Furthermore, large-scale production is achievable by proportionally increasing the concentrations of metal ion precursors, reducing agents, and surfactants, demonstrating significant potential for industrial-scale production of molecule-modified ultra-thin RhCu nanostructures.

### CROSS-REFERENCE TO RELATED APPLICATIONS

The present application claims the priorities from the U.S. provisional patent application Ser. No. 63/588,295 filed Oct. 6, 2023, and the disclosure of which is incorporated herein by reference in its entirety.

### FIELD OF THE INVENTION

The present invention pertains to the field of electrochemical energy storage and catalysis. In particular, the present invention relates to surface molecular modification of ultrathin RhCu metallenes.

### BACKGROUND OF THE INVENTION

Zinc-nitrate batteries have emerged as promising energy storage systems with the potential to revolutionize various applications, including providing high-energy supply, enabling ammonia (NH₃) electrosynthesis, and facilitating sewage disposal. These batteries are considered competitive candidates for next-generation power accessories on the way towards sustainable development of humankind. However, current zinc-nitrate batteries are facing technical hurdles of limited energy density and poor rechargeability.

NH₃ and its derivatives, such as fertilizers, hold tremendous importance for the sustainable development of the Earth's biosphere. Nitrate reduction reaction (NO₃RR) is considered a promising method for achieving high-yield NH₃ production, thereby avoiding the need for the harsh conditions (450-500° C., 200 atm) and limited conversion percentages (10-20%) associated with the energy-intensive industrial Haber-Bosch process. Based on this, it is profound to construct durable and eco-friendly secondary energy storage and conversion devices that can produce NH₃ from waste water containing NO₃⁻/NO₂⁻ while outputting electricity to external circuits.

According to the general working principles, the NO₃RR activity of cathode catalysts is a key factor that determines the electrochemical performance of assembled Zn—NO₃⁻ batteries. Copper (Cu) is the most commonly-used catalyst for NO₃RR, which can electrochemically convert NO₃⁻ into NH₃ with relatively good Faradaic efficiencies (FEs). Existing technologies focus on optimizing the composition of Cu-based aggregates to improve the adsorption of protons on Cu to reduce the overpotential of NO₃RR but they are still operated at quite negative applied potentials (approximately −0.4 to −0.7 V (vs. reversible hydrogen electrode (RHE)) to ensure moderate FEs in neutral media (<−0.6 V vs. RHE) and the mass specific capacity is unsatisfactory owing to the quite low materials utilization efficiency. Meanwhile, most of existing Cu-based catalysts are designed for monofunctional NO₃RR so that they are not suitable or stable for oxidation reactions. It makes their assembled zinc-nitrate batteries non-rechargeable or have a large charge plateau and quite limited cycling life.

On the other hand, most reported catalysts are designed for monofunctional NO₃RR, their inferior electrocatalytic activity and structural stability toward oxidation reactions makes the batteries non-rechargeable or have a large charge plateau and quite limited cycling life.

Zinc-nitrate (Zn—NO₃⁻) batteries have been considered as a promising option for next-generation power solutions, combining energy supply, ammonia electrosynthesis, and sewage disposal into a single electrochemical device. Zinc-nitrate batteries process a high theoretical energy density of 1051 Wh kg⁻¹ can be established after coupling NO₃RR (cathodic reaction) with a redox pair of Zn²⁺/Zn (anodic reaction) (E^{θ}(Zn²⁺/Zn)=−1.27 V (vs. standard hydrogen electrode (SHE), via Zn+2OH⁻⇄ZnO+H₂O+2e⁻)¹⁻². Such self-powered metal-NO₃⁻ battery combines energy supply, NH₃ electrosynthesis and sewage disposal (e.g., removing NO₃⁻-based pollutants), which enables it very attractive for the development of next-generation, high-performance and eco-friendly power sources towards distributed stationary energy storage and electric vehicles.

Guo, Ying, et al. suggests a zinc-nitrate battery configured within H-cells, employing carbon cloth-supported Pd-doped TiO₂ nanoarrays as the cathode³. The cathodic electrolyte consists of an aqueous mixture containing 0.25 M LiNO₃ and 5 M LiCl, while the anodic electrolyte comprises a 5 M KOH solution. However, the battery is designed exclusively for discharge in galvanic cell mode and is a non-rechargeable battery.

Existing zinc-nitrate batteries are encountering issues related to low energy density and inadequate rechargeability. In light of these challenges, the quest to develop rechargeable zinc-nitrate batteries with both high energy density and extended cycling lifespan remains a formidable and critical endeavor in the field of electrochemical energy storage. The present invention addresses these challenges.

### SUMMARY OF THE INVENTION

In this invention, a molecule-metal relay catalysis strategy is proposed to enhance the conversion of NO₃⁻ to NH₃ at low overpotentials in neutral solution.

The present invention also provides a method for synthesizing tetraphenylporphyrin (tpp) modified heterophase (amorphous/crystalline) tpp (RhCu M-tpp) and optimizing electrolyte composition to enable efficient NO₃RR and ethanol oxidation reaction (EOR) in neutral medium. This approach enables the development of rechargeable, low-overpotential and durable zinc-nitrate/ethanol batteries.

In a first aspect, the present invention provides a rechargeable zinc-nitrate/ethanol battery, which includes a cathode having a conductive substrate coated with one or more copper-based catalysts having a heterophase structure; an anode; a separator placed between the cathode and the anode; an anolyte on the anode side; and a catholyte on the cathode side. The rechargeable zinc-nitrate/ethanol battery demonstrates an energy density of at least 110,000 Wh kg⁻¹_{cat}, a power density of at least 1.5 mW cm⁻², long-term cycling stability of approximately 400 cycles.

In one embodiment, the one or more copper-based catalysts include tetraphenylporphyrin modified rhodium-copper alloy metallene, with a 2θ value of 41°-42°.

In one embodiment, the tetraphenylporphyrin modified rhodium-copper alloy metallene contains 60-85 wt % of Rh and 15-40 wt % of Cu.

In one embodiment, the tetraphenylporphyrin modified rhodium-copper alloy metallene exhibits a micrometer-sized self-assembly network, with interconnected two-dimensional flexible nanosheets.

In one embodiment, a conversion of NO₃⁻ to NH₃ occurs at a low overpotential less than −0.1 V, the NO₃⁻ is firstly adsorbed and subsequently reduced to NO₂ on tetraphenylporphyrin, and then NO₂ diffuses to Cu sites for a subsequent hydrogenation process assisted by surrounding rhodium atoms toward NH₃ production.

In one embodiment, the tetraphenylporphyrin modified rhodium-copper alloy metallene has a NH₃ yield rate increasing with a decreasing potential, nearly 6 times higher than that of an unmodified rhodium-copper alloy metallene.

In one embodiment, the tetraphenylporphyrin modified rhodium-copper alloy metallene exhibits two ethanol oxidation peaks at 0.8 and 0.4 V compared to a reversible hydrogen electrode in an alkaline solution with alcohol comprising EtOH, MeOH, or ethylene glycol.

In one embodiment, the tetraphenylporphyrin modified rhodium-copper alloy metallene achieves an ammonia Faradaic efficiency (FE) of at least 70% with a potential above −0.4 V.

In one embodiment, the zinc-nitrate/ethanol battery demonstrates a decrease in charge plateau of approximately 130 mV at 0.1 mA cm⁻² and maintains normal function for at least 40 hours.

In one embodiment, the conductive substrate includes conductive carbon cloth or glassy carbon electrode.

In one embodiment, the anode includes zinc plate.

In one embodiment, the separator includes bipolar membrane.

In one embodiment, the anolyte includes 1 M KOH aqueous solution with 0.02 M Zn(CH₃COO)₂, and the catholyte comprises a mixture of 0.5 M Na₂SO₄/3000 ppm NO₃⁻ solution and 1 M ethanol.

In one embodiment, the heterophase structure includes a crystalline domain and an amorphous domain.

In a second aspect, the present invention provides a method for synthesizing a heterophase tetraphenylporphyrin modified rhodium-copper alloy metallene. The method includes co-reducing rhodium (Rh) and copper (Cu) precursors in an oleylamine solution to obtain RhCu metallenes; adding at least one reductant and at least one surfactant for surface modifying the RhCu metallenes; heating the RhCu metallenes in an oil bath at 160° C. for 12 hours to obtain modified RhCu metallenes; subjecting the modified RhCu metallenes to ligand exchange in chloroform dissolved with tetraphenylporphyrin and centrifugating at 10,000 rpm for 5 minutes to obtain the heterophase tetraphenylporphyrin modified rhodium-copper alloy metallene.

In one embodiment, the Rh and Cu precursors have a feeding ratio of 8:1 based on molar quantity.

In one embodiment, the heterophase tetraphenylporphyrin modified rhodium-copper alloy metallene has a thickness in a range of 0.01 nm to 1 nm

In one embodiment, the tetraphenylporphyrin modified rhodium-copper alloy metallene contains 60-85 wt % of Rh and 15-40 wt % of Cu, and the Rh and Cu have an elemental ratio of 4:1 based on molar quantity.

In one embodiment, the at least one reductant includes 1, 2-butylene glycol, and the at least one surfactant includes potassium iodide.

In one embodiment, the RhCu M and the tetraphenylporphyrin has a ratio of 95:5.

In one embodiment, the heating is conducted at a reaction temperature ranging from 155-180° C.

In one embodiment, the tetraphenylporphyrin has a concentration in a range of 5-100 mM.

The present invention has the following advantages:
(1) The present invention combines catalyst design and electrolyte optimization to address the aforementioned issues. The synthetic procedure of RhCu M-tpp catalysts shows great promise in large-scale production. Meanwhile, the proposed electrolyte optimization method is cost-effective, which may also make positive effect on other advanced metal-catalysis coupled energy conversion and storage devices.
(2) Experimental investigations and density functional theory (DFT) calculations have demonstrated that the electroactivity of interfaces between crystalline and amorphous RhCu is further enhanced by the introduction of tpp, providing a wider range of active sites for nitrate reduction. The surface-bound tpp acts as the primary active site for NO₃⁻ reduction to NO₂⁻, while the subsequent reduction is accelerated by the interface regions. This collective action contributes to efficient electrocatalysis.
(3) The RhCu M-tpp-based Zn-nitrate/ethanol batteries demonstrate ultra-high energy density, higher power density, a smaller discharge-charge voltage difference, superior long-term cycling stability, which largely exceeds the performance of commercial Cu particle-based counterparts. Few existing metal-catalysis coupled aqueous batteries can exhibit such comprehensive performance and multifunctionality.

### BRIEF DESCRIPTION OF THE DRAWINGS

Embodiments of the invention are described in more details hereinafter with reference to the drawings, in which:

FIG. 1A shows a schematic illustration for the synthetic procedure of RhCu M-tpp and the working principle of assembled Zn-nitrate/ethanol batteries. FIG. 1B depicts XRD pattern of as-synthesized RhCu M-tpp. FIG. 1C shows highmagnified SEM images of synthesized RhCu M-tpp and RhCu M. FIG. 1D depicts EDS spectrum of RhCu M-tpp and RhCu M. Insets showing the elemental ratio between Rh and Cu. FIG. 1E shows XRD pattern of as-synthesized RhCu M-tpp. FIG. 1F depicts EELS spectra of RhCu M-tpp, RhCu M, and carbon support in Cu grid;

FIG. 2 depicts FT-IR spectra of commercial tpp powders (top panel) and as-synthesized RhCu M-tpp (bottom panel);

FIGS. 3A-3D show typical low-dose HAADF-STEM images of RhCu M-tpp;

FIGS. 4A-4C show low-dose HAADF-STEM image taken at 1 Pa showing the crystalline and amorphous domains within RhCu M-tpp in-plane structures and the selected-area FFT patterns ascribed to the regions. FIG. 4D shows zoom-in HAADF-STEM image showing the crystalline and amorphous domains;

FIGS. 5A-5D depict HAADF-STEM image and the corresponding elemental mappings of Rh, Cu and N of the RhCu M-tpp;

FIG. 6A depicts normalized Cu K-edge XANES spectra of RhCu M-tpp, RhCu M and Cu NPs. Inset: the zoom-in graph showing the detailed white line positions. The data for reference samples of Cu foil, Cu₂O and CuO are included for comparison. FIG. 6B depicts R-space EXAFS of RhCu M-tpp, RhCu M and Cu NPs. FIG. 6C depicts fitting results of the EXAFS spectrum of RhCu M-tpp at Cu K edge. FIG. 6D depicts R-space EXAFS fitting of RhCu M-tpp, RhCu M and Cu NPs;

FIG. 7A shows wavelet transform of RhCu M-tpp, RhCu M and Cu NPs. FIG. 7B shows wavelet transforms of the Cu K-edge EXAFS spectra for Cu foil and CuO;

FIG. 8A depicts survey XPS spectra of RhCu M-tpp, RhCu M and Rh M. FIG. 8B depicts high-resolution Rh 3d XPS spectra of RhCu M-tpp, RhCu M and Rh M;

FIG. 9A depicts high-resolution XPS spectra of Cu 2p for RhCu M-tpp, RhCu M and Cu NPs or tpp. FIG. 9B depicts Cu LMM AES spectra for RhCu M-tpp, RhCu M and Cu NPs. FIG. 9C depicts high-resolution XPS spectra of N is for RhCu M-tpp, RhCu M and Cu NPs or tpp;

FIG. 10 depicts LSV curves of RhCu M-tpp, RhCu M, Rh M and Cu NPs in neutral 0.5 M Na₂SO₄ solution in the presence (solid lines) and absence (dashed lines) of 3000 ppm NO₃⁻ at 5 mV s⁻¹;

FIG. 11 depicts FEs of NH₃ and NO₂⁻ on RhCu M-tpp, RhCu M, Rh M and Cu NPs under different applied potentials;

FIG. 12 depicts NH₃ yield rates on RhCu M-tpp, RhCu M, Rh M and Cu NPs under different applied potentials;

FIGS. 13A-13C depict CA curves at different applied potentials for RhCu M-tpp, Rh M and Cu NPs. FIG. 13D depicts NH₃ partial current densities for RhCu M-tpp, RhCu M, Rh M and Cu NPs at the aforementioned potentials;

FIG. 14A depicts fitting results of double layer capacitance (C_{dl}) for RhCu M-tpp and RhCu M. FIG. 14B depicts Cyclic voltammetry profiles obtained on RhCu M-tpp and RhCu M cathodes near OCP with the scan rates of 20, 40, 60, 80 and 100 mV s⁻¹;

FIG. 15 depicts NH₃ yielding amount of RhCu M-tpp after 1 h electrolysis using ¹⁴NO₃⁻ or ¹⁵NO₃⁻ as the nitrogen resources at −0.2 V (vs. RHE), quantified by both UV-vis and NMR methods. The NH₃ amounts recorded in the cases without applied potential but in the presence of NO₃⁻ and without NO₃⁻ at −0.2 V (vs. RHE) are also provided. Inset: the ¹H NMR spectra of electrolytes after NO₃RR using ¹⁴NO₃⁻ or ¹⁵NO₃⁻;

FIG. 16 depicts FEs and yield rates of NH₃ on RhCu M-tpp during 6 cycles of 1 h electrolysis at −0.2 V (vs. RHE);

FIGS. 17A-17B depict CV profiles of RhCu M-tpp and RhCu M at 50 mV s⁻¹ over the potential window of 0.05-1.1 V (vs. RHE) in 1 M KOH and 1 M KOH+1 M EtOH solutions. FIG. 17C depicts chronoamperometric curves of RhCu M-tpp and RhCu M tested in 1 M KOH+1 M EtOH at 1 V (vs. RHE) within 3600 s. FIG. 17D depicts mass activity of RhCu M-tpp and RhCu M at 0.8 V (vs. RHE) (left panel) and at 1800 s under 1 V (vs. RHE) (right panel);

FIGS. 18A-18C show low-magnification HAADF-STEM images showing the morphology of RhCu M-tpp after EOR test. FIG. 18D shows a high-magnification HAADF-STEM image showing the holey and ultrathin metallene nanostructures. FIG. 18E shows an atomic-resolution HAADF-STEM image depicting the amorphous domain of RhCu M-tpp after EOR tests in 1 M KOH+1 M EtOH solution. FIG. 18F shows an atomic-resolution HAADF-STEM image depicting the crystalline domain of RhCu M-tpp after EOR tests in 1 M KOH+1 M EtOH solution;

FIG. 19A depicts OCV profile within the initial 24 h of the assembled Zn—NO₃⁻ batteries using RhCu M-tpp with routine electrolyte in the absence of ethanol. FIG. 19B depicts ate capability during discharge process of the assembled Zn—NO₃ ⁻ batteries using RhCu M-tpp with routine electrolyte in the absence of ethanol;

FIG. 20A depicts OCV profiles within the initial 24 h of Zn—NO₃⁻ galvanic cells (using electrolyte without ethanol) and rechargeable Zn-nitrate/ethanol batteries (using electrolyte with ethanol). FIG. 20B depicts rate performances at discharging of Zn—NO₃⁻ galvanic cells (using electrolyte without ethanol) and rechargeable Zn-nitrate/ethanol batteries (using electrolyte with ethanol);

FIG. 21A depicts rate capability of Zn-nitrate/ethanol batteries with RhCu M-tpp and Cu NPs when discharging. FIG. 21B depicts galvanostatic discharge profiles of Zn-nitrate/ethanol batteries with RhCu M-tpp cathodes from OCV to 0.005 V (vs. Zn²⁺/Zn) at 0.1 and 0.5 mA cm⁻², respectively. Inset: a digital photograph showing the constructed battery device, along with the measurement of OCV. FIG. 21C depicts discharging polarization profiles and resultant power density curves of Zn-nitrate/ethanol batteries using RhCu M-tpp and Cu NPs. FIG. 21D depicts LSV curves from 0.6 to 1.8 V (vs. RHE) of RhCu M-tpp cathodes in the electrolytes with and without ethanol after NO₃RR. Inset: The digital photographs of the reaction phenomena on electrodes during anodic scanning with (right panel) and without (left panel) ethanol, respectively;

FIG. 22 shows voltage difference as a function of current density. The voltage difference (ΔV=VOER−VEOR) between anodic LSV curves ascribed to Zn—NO₃⁻ batteries using ethanol-free electrolyte and ethanol-contained electrolyte;

FIG. 23A depicts round-trip discharge-charge profiles of Zn-nitrate/ethanol battery with RhCu M-tpp at different current densities. FIG. 23B depicts discharge-charge profiles at different current densities of the Znnitrate/ethanol batteries based on RhCu M-tpp. FIG. 23C depicts calculated energy efficiency of the Znnitrate/ethanol batteries based on RhCu M-tpp.

FIG. 23D depicts long-term cycling stability test of as-assembled Zn-nitrate/ethanol and Zn-nitrate batteries. FIG. 23E depicts long-term cycling stability at a high rate. Electrochemical behaviour of the constructed RhCu M-tpp based rechargeable Zn-nitrate/ethanol batteries at 0.5 mA cm⁻² (equal to 1.25 A gcat⁻¹). Every cycle includes a galvanostatic discharging for 5 min and subsequent recharging for 5 min, and the battery could steadily last for approximately 400 cycles;

FIG. 24A depicts 1H NMR spectra for solutions with HAc concentrations of 0, 2.5, 5, 7.5, 10, 15 and 20 ppm. FIG. 24B depicts calibration curve of the solutions with given HAc concentrations. FIG. 24C depicts 1H NMR spectrum of the cathodic electrolyte after dilution for 60 folds, which was taken from a rechargeable Zn-nitrate/ethanol battery at the 300^{th} cycle.

FIG. 24D depicts HAc concentrations, HAc increase rates and corresponding energy efficiencies of the battery at the selected cycles;

FIG. 25 depicts ¹H NMR spectra of the utilized electrolytes at the pristine, discharged and charged states;

FIG. 26A depicts typical TEM image of RhCu M-tpp after the long-term cycling.

FIG. 26B depicts HRTEM image of RhCu M-tpp after the long-term cycling. FIG. 26C depicts EDS spectrum of RhCu M-tpp after the long-term cycling test. Inset: a table showing the elemental ratio between Rh and Cu. FIG. 26D depicts high-resolution Rh 3d and Cu 2p XPS spectra for the RhCu M-tpp cathode extracted from a Zn-nitrate/ethanol battery after the long-term cycling test;

FIG. 27A depicts FE(NO₂⁻)/FE(NO₂⁻)+FE(NH₃) ratios at different applied potentials for pure tpp, RhCu M and RhCu M-tpp. FIG. 27B depicts electric quantity consumption rates of NO₃RR normalized to ECSA for RhCu M-tpp and RhCu M under different potentials;

FIG. 28A depicts in-situ DEMS patterns for a RhCu M-tpp cathode during NO3RR in 0.5 M Na₂SO₄+3000 ppm NaNO₃. Five periods of cathodic LSV from 0.2 to −0.7 V (vs. RHE) are repeated to improve the detection reliability. FIGS. 28B-28C depict Digital photographs depicting the utilized H-cells with different configurations for water-soluble NO₂ ⁻ and NH₃ quantitation (FIG. 28B) and gaseous H₂ quantitation (FIG. 28C). FIG. 28D depicts Faradaic efficiencies towards H₂ of RhCu M-tpp and RhCu M cathodes during NO₃RR at −0.2 and −0.5 V (vs. RHE);

FIG. 29 shows surface potential distribution mapping of RhCu M-tpp;

FIG. 30 depicts potential line scan of RhCu M-tpp;

FIGS. 31A-31B depict In-situ DEMS patterns for RhCu M-tpp cathodes during the initial NO₃RR (FIG. 31A) and the subsequent EOR (FIG. 31B). Four periods of cathodic and anodic LSV scanning are conducted to drive the electrocatalytic reactions;

FIG. 32 depicts in-situ DEMS pattern for RhCu M-tpp cathodes during three periods of ordered cathodic (NO₃RR) and anodic (EOR) LSV scanning. The cathodic LSV was conducted from 0 to −0.66 V (vs. RHE) and the anodic LSV was performed from 0.551 V to 1.6 V (vs. RHE) at 6 mV s⁻¹;

FIG. 33A shows 3D contour plots of electronic distributions near the Fermi level of RhCu M-tpp. FIG. 33B shows 3D contour plots of electronic distributions near the Fermi level of RhCu M. FIG. 33C depicts PDOSs of RhCu M-tpp. FIG. 33D depicts PDOSs of NO₃⁻ adsorption on RhCu M-tpp. FIG. 33E shows the site-dependent PDOSs of Cu-3d in crystal and amorphous parts (left two panels) and Rh-4d in crystal and amorphous parts (right two panels) in RhCu M-tpp. FIG. 33F depicts the reaction energy comparisons of nitrate reduction on RhCu M-tpp and RhCu M. FIG. 33G depicts the adsorption energy comparisons of key intermediates on different sites of RhCu M-tpp. IF=Interface, Crystal=Crystal part of RhCu, Amorph=Amorphous part of RhCu; and

FIG. 34 shows digital photographs of a commercial digital clock powered by the constructed Zn-nitrate/ethanol battery for continuous running above 24 h.

### DETAILED DESCRIPTION

Metal-based nanomaterials have garnered significant research interest in the field of clean energy. Currently, lithium-ion batteries (LIBs) serve as the predominant choice for powering portable electronics and stationary energy storage devices. Nevertheless, the further advancement of LIBs faces challenges due to their limited energy storage capacity and the Earth's limited reserves of cobalt and lithium. Developing next-generation, high-energy-density secondary battery systems with environmentally-friendly attributes is a significant undertaking. However, relevant studies are still in their infancy, making it crucial to establish promising technological foundations that can pave the way for subsequent industrialization of optimal technical processes.

In general, most of the Cu-based catalysts exhibited the best performance for NO₃RR at quite negative applied potentials (approximately −0.4 to −0.7 V (vs. RHE) in alkaline solutions, while more negative around −0.6 to −1.2 V (vs. RHE) in neutral solutions) due to the weak adsorption of Cu towards protons⁴⁻⁵. To achieve this, a significant overpotential is necessary to enhance proton coverage on Cu surfaces and overcome the high energy barrier of hydrogenation. This reduction in equilibrium potential gaps (i.e., working voltages of Zn—NO₃⁻ batteries) between cathodic NO₃⁻/NH₃ and anodic Zn²⁺/Zn pairs is essential. On the other hand, the ammonia yield rates remain unsatisfactory due to the limited atomic utilization efficiency of large-sized Cu agglomerates. This limitation severely impacts the mass-specific capacity of cathode catalysts. Due to these issues, the practical energy density of assembled Zn—NO₃⁻ batteries is significantly suppressed. Realizing sufficient Faradaic efficiencies (FEs) of NH₃ within the low-overpotential range (e.g., potential >−0.4 V vs. RHE) remains a significant challenge, especially in neutral electrolytes.

Accordingly, the present invention offers a high-performance rechargeable zinc-nitrate/ethanol batteries in H-cells, where the heterophase RhCu M-tpp functions as a bifunctional catalyst for efficient NO₃RR (discharge) and EOR (charge) in a cathodic neutral electrolyte, while a zinc (Zn) plate acts as the metal anode in an anodic alkaline electrolyte. NO₃RR is regarded as a promising approach to produce NH₃ in a high yield rate, owing to the relatively low bond energy (204 kJ mol⁻¹) of N=O and good solubility of nitrate (NO₃⁻).

In one embodiment, the rechargeable zinc-nitrate/ethanol battery includes a cathode, an anode, a separator placed between the cathode and the anode, an anolyte on the anode side and a catholyte on the cathode side.

In one embodiment, the cathode is made by a conductive substrate coated with one or more copper-based catalysts having a heterophase structure. The one or more copper-based catalysts may include tetraphenylporphyrin modified rhodium-copper alloy metallene. The tetraphenylporphyrin modified rhodium-copper alloy metallene exhibits a micrometer-sized self-assembly network, with interconnected two-dimensional flexible nanosheets.

In one embodiment, the heterophase structure comprises a crystalline domain and an amorphous domain. Iodide ions acted as both complexing and capping agents, inducing the formation of two-dimensional (2D) nanostructures instead of zero-dimensional (OD) ones.

The tetraphenylporphyrin modified rhodium-copper alloy metallene has a NH₃ yield rate increasing with a decreasing potential (can reach the maximum point of 717.8 mg h⁻¹ g⁻¹_{cat}), nearly 6 times higher than that of an unmodified rhodium-copper alloy metallene.

In addition, the tetraphenylporphyrin modified rhodium-copper alloy metallene exhibits two ethanol oxidation peaks at 0.8 and 0.4 V compared to a reversible hydrogen electrode in an alkaline solution with alcohol comprising EtOH, MeOH, or ethylene glycol. Ethanol (EtOH) is introduced into the NO₃RR electrolyte to replace OER with ethanol oxidation reaction (EOR) in order to boost the energy economy during charging.

In one embodiment, the alkaline solution may include 1M KOH aqueous solution.

The tetraphenylporphyrin modified rhodium-copper alloy metallene achieves an ammonia Faradaic efficiency (FE) of at least 70% with a potential above −0.4 V. The highest ammonia FE can be 84.8% at −0.2 V (vs. RHE).

In particular, the tetraphenylporphyrin modified rhodium-copper alloy metallene contains 10-20 wt % of Cu and 70-85 wt % of Rh.

Preferably, the tetraphenylporphyrin modified rhodium-copper alloy metallene contains 15 wt % of Cu and 84.38 wt % of Rh.

Conversion of NO₃⁻ to NH₃ occurs at a low overpotential less than −0.1V, the NO₃⁻ is firstly adsorbed and subsequently reduced to NO₂⁻ on tetraphenylporphyrin, and then NO₂⁻ diffuses to Cu sites for a subsequent hydrogenation process assisted by surrounding rhodium atoms toward NH₃ production.

In one embodiment, the conductive substrate may be conductive carbon cloth or glassy carbon electrode. The anode may be 2 cm×2 cm square zinc plate manufactured by Sheng Er Nuo Co. LTD, or any commercially available zinc plate. The separator may be bipolar membrane. For example, the (D2.5 cm, FBM-PK, manufactured by Sheng Er Nuo Co. LTD or BMS manufactured by Membrane Technology & Research, Inc, or any commercially available bipolar membrane.

In one embodiment, the electrolytes can be customized according to the category of organic ammoniates required. For example, the anolyte comprises 1 M KOH aqueous solution with 0.02 M Zn(CH₃COO)₂, and the catholyte comprises a mixture of 0.5 M Na₂SO₄/3000 ppm NO₃⁻ solution and 1 M ethanol. The salts can be substituted with one or the mixture of other common alkaline metal salts, such as Li₂SO₄, K₂SO₄, LiNO₃, KNO₃, and the like. Additionally, small molecular alcohols like methanol, glycerol and benzyl alcohol, can also replace C₂H₅OH and play the similar role of being oxidized within the electrolyte.

The rechargeable zinc-nitrate/ethanol battery demonstrates an energy density of at least 110,000 Wh kg⁻¹_{cat}, a power density of at least 1.5 mW cm⁻², long-term cycling stability of approximately 400 cycles. Preferably, the constructed batteries deliver an outstanding energy density of 117364.6 Wh kg⁻¹_{cat}, superior rate capability, excellent cycling stability of at least 400 cycles, and ammonium acetate production.

In a second aspect of the present invention, the present invention provides a facile one-pot wet-chemical growth together with ligand exchange method using commercial chemicals and easily approachable equipment. Through varying the feeding ratio of raw materials, the morphology, composition, purity and size of RhCu M-tpp are adjustable. Large-scale production is feasible via enlarging the concentrations of metal ion precursors, reductants and surfactants proportionally, revealing high feasibility for industrial-level production of molecule-modified ultrathin RhCu nanostructures.

RhCu M-tpp is prepared by a facile ligand exchange method. Typically, RhCu metallenes (RhCu M) is dispersed in chloroform containing tetraphenylporphyrin (tpp). The slurry is kept stirring for 24 h at room temperature for sufficient ligand exchange. Finally, the sediments can be collected by centrifugation and washed with chloroform/ethanol (v/v=1/1) solution for several times.

In one embodiment, at least one reductant may be 1, 2-butylene glycol, and the at least one surfactant may be potassium iodide.

In one embodiment, the RhCu M and the tetraphenylporphyrin has a ratio of 95:5.

In one embodiment, the tetraphenylporphyrin has a concentration in a range of 5-100 mM.

The exceptional bifunctionality of the RhCu M-tpp catalyst used in these batteries contributes to enhanced work efficiency and energy savings by improving energy density and reducing discharge-charge overpotentials in these devices. Moreover, by altering the category of added alcohols, the recycled electrolyte can yield several value-added ammonium salts. Rechargeable metal-nitrate/alcohol batteries, which constitute the primary potential applications of this invention, hold significant appeal as future high-performance and environmentally friendly power sources for distributed stationary energy storage and electric vehicles.

### EXAMPLE

### Example 1

### Materials and Methods

### Chemicals and Materials

Rhodium acetylacetonate (Rh(acac)₃, 97% metal basis), copper acetylacetonate (Cu(acac)₂, ACS reagent, ≥99.5%), tetraphenylporphyrin (tpp, 95%), potassium iodide (KI, AR), oleylamine (OAm, 70%, technical grade), n-hexane (anhydrous, 99.5%), and ethanol (anhydrous, ≥99.9%) were purchased from Sigma-Aldrich. 1, 2-butanediol (1,2-BDO, 99.5%, AR), sodium sulfate (Na₂SO₄), sodium nitrate (Na¹⁴NO₃, anhydrous, ≥99.0%), ¹⁵N-labeled sodium nitrate (Na¹⁵NO₃, anhydrous, ≥99.0%), deuterium oxide (D₂O, 99.9%ₐₜ D), sodium hydroxide (NaOH, >98%), salicylic acid (C₇H₆O₃, 99%), acetic acid (CH₃COOH, HAc, >97%), sodium citrate (C₆H₅Na₃O₇, AR), sodium nitroferricyanide dehydrate (C₅FeN₆Na₂O·2H₂O, 99%), hydrogen peroxide (H₂O₂, 30%), maleic acid (C₄H₄O₄, 98%), sodium hypochlorite solution (NaClO, AR, active chlorine 6-14%_{wt}) and the other chemicals without special mention were purchased from Aladdin. Carbon papers (Toray TGP-H-060), Nafion solution (5%_{wt} in ethanol), Nafion 117 membranes and bipolar membranes were purchased from Fuel Cell Earth. Ultrapure Milli-Q distilled water (Milli-Q System, Millipore) was used in the experiments. All the chemicals were used as received without any further purification.

### Electrocatalytic Measurements

Before electrochemical measurements, Nafion 117 membrane was immersed in 5% wt H₂O₂ at 80° C. for 1 h and then in distilled water at 80° C. for another 1 h for activation and purification. All the NO₃RR performances were evaluated in H-cells separated by activated Nafion 117 membranes in ambient environment. The CP-supported catalysts, Ag/AgCl electrode, and platinum (Pt) plate (1×1 cm²) were used as the working electrode, reference electrode and counter electrode, respectively. An Ar-saturated solution containing 0.5 M Na₂SO₄ and 3000 ppm NaNO₃ acted as both the cathodic and anodic electrolyte. Note that all the working electrodes were subject to cyclic voltammetry (CV) scanning over the potential window of −0.351 to −1.351 V (vs. RHE) for 60 cycles in 0.5 M Na₂SO₄. LSV measurements were carried out using a three-electrode system at a scan rate of 5 mV s⁻¹ in the electrolyte with or without NO₃⁻. Chronoamperometry (CA) tests were conducted at a series of different applied potentials with 85% IR compensation in a typical H-cell with 25 mL of electrolyte in anodic side and cathodic side under a stirring rate of 600 rpm to accelerate mass transfer.

All the electrochemical measurements were implemented on an Ivium electrochemical workstation (Ivium-n-Stat, Netherlands). All potentials were referred to RHE in this work unless specification, according to the following formula:

$$E ( RHE ) = E ( Ag / AgCl ) + 0.197 + 0.0 \; 59 \times pH .$$

In-situ differential electrochemical mass spectrometry (DEMS) was performed on a Linglu DEMS analysis system, where glassy carbon electrode coated with RhCu M-tpp electrocatalysts, Pt wire, and saturated Ag/AgCl electrode were utilized as the working electrode, counter electrode, and reference electrode, respectively, in a specially designed probe-type DEMS cell.

For NO₃RR, four periods of cathodic LSV from 0 to −0.66 V (vs. RHE) at 6 mV s⁻¹ were conducted to drive the reaction. There was a rest interval between adjacent LSV processes until the NH₃ signal recovered to the initial state. After recording the data, the assembled probe-type DEMS cell had experienced a 2 h electrocatalysis at −0.851 V (vs. RHE) to simulate the NH₃ production during discharging. In the following, another four periods of anodic LSV from 0.551 to 1.6 V (vs. RHE) at 6 mV s⁻¹ were implemented to enable EOR. By monitoring the signal changes of target mass-to-charge ratios, the intermediates and products formed in different electrochemical processes could be identified.

### Determination of Ammonia and Nitrite

To determine the amount of NH₃ produced after NO₃RR for 1 h at various conditions, indophenol blue method was employed. In detail, 1 mL of electrolyte was taken out after test and diluted with distilled water at suitable folds. Firstly, 2.5 mL of solution A (composed of 0.625 M NaOH, 0.36 M salicylic acid and 0.17 M sodium citrate) were added. Then, 300 μL of solution B (sodium nitroferricyanide,10 mg mL⁻¹) and 150 μL of solution C (NaClO, active chlorine 6-14%_{wt}) were added, successively. It was then subject to adequate vortex for homogeneous mixing and then kept without disturbance for 3 h under ambient environment. Next, UV-vis spectrophotometry was used to examine the absorbance values at 660 nm of these mixed solutions, and the NH₃ concentrations could be obtained according to the standard curves. The amount of generated NH₃ was also calculated by ¹H NMR method. 1 mL of electrolyte after NO₃RR was added with 10 μL of C₄H₄O₄ which acted as the quantitative reference. After that, 50 μL of 4 M H₂SO₄ were further introduced to provide a weak acid environment. Subsequently, 450 μL of the above mixed solution were added with 50 μL of D₂O for NMR tests. The integral peak area ratios between NH₄⁺ and C₄H₄O₄ were calculated and the corresponding NH₄⁺ concentrations could be determined according to the standard curve. The standard NH₄⁺ solutions with given concentrations of (NH₄)₂SO₄ in 0.05 M H₂SO₄ were prepared to establish the calibration curves for UV-vis and NMR methods. As for the ¹⁵N-labeling experiments, all the electrochemical operations and quantitative analysis were the same except for using ¹⁵NaNO₃ as the nitrogen resources.

To determine the amount of NO₂⁻, 1 mL of electrolyte was taken out after test and diluted with distilled water at suitable folds. Then, 10 μL of N-(1-Naphthyl) ethylenediamine dihydrochloride solution (10 mg mL⁻¹) were dropped into the diluted electrolyte. After 20 min, these solutions were measured by UV-vis spectrophotometry. The absorbance values at 540 nm were recorded to calculate the concentrations of NO₂⁻ according to the standard curve. The standard calibration curve could also be acquired by using the standard NO₂⁻ solutions with given concentrations of NaNO₂.

Faradaic efficiencies (FEs) and weight-normalized yield rates of NH₃ and NO₂⁻ were calculated by the following equations:

$$FE ( {NH}_{3} ) = ( 8 \times F \times M \times V \times {D}_{n} ) / Q \\ {NH}_{3} yield rate = ( 17 \times M \times V \times {D}_{n} ) / ( t \times W ) \\ FE ( {NO}_{2}^{-} ) = ( 2 \times F \times M \times V \times {D}_{n} ) / Q \\ {NO}_{2}^{-} yield rate = ( 46 \times M \times V \times {D}_{n} ) / ( t \times W )$$

where F is the Faraday constant (96485 C mol⁻¹), M is the measured concentration of NH₃ or NO₂⁻, V is the volume of used electrolyte (0.025 L), Q is the total amount of charge transfer during NO₃RR, Dₙ is the dilution factor, t is the reaction time, and W is the mass loading of working electrodes.

### Electrocatalytic EOR Measurements

All the EOR performances were evaluated using the same H-cells for NO₃RR tests. The CP-supported catalysts, Ag/AgCl electrode, and platinum (Pt) plate (1×1 cm²) were also used as the working electrode, reference electrode and counter electrode, respectively. Before measurements, all the working electrodes were activated through CV sweeping over the potential window of 0.05-0.8 V (vs. RHE) for 60 cycles in Ar-saturated 1 M KOH. After that, EOR performances were tested in the mixture of 1 M KOH and 1 M EtOH under stirring at 600 rpm over the potential window of 0.05-1.1 V (vs. RHE). CA tests were conducted at 1 V (vs. RHE) with 85% IR compensation in a typical H-cell with 25 mL of electrolyte in the anodic side and cathodic side.

### Determination of Acetic Acid (HAc)

The amount of HAc produced during the cycling of Zn-nitrate/ethanol batteries was calculated by ¹H NMR method. Firstly, 1.5 mL of the cathodic electrolyte was taken from the battery after given cycles and diluted at suitable folds using distilled water. After that, 600 μL of the diluted solution was added with 30 μL of DMSO/D₂O mixture in which DMSO acted as the quantitative reference for NMR measurements. The integral area ratios between HAc and DMSO peaks were calculated and the corresponding HAc concentrations could be calculated based on the calibration curve. The standard HAc solutions with given concentrations were prepared to obtain the standard curves and then establish the calibration curve accordingly by NMR methods.

### Characterization

The order of magnitude of the electron dose was down to the 10³ e Å⁻². The FT-IR spectra were recorded on a Bruker TENOR 27 spectrophotometer employing the KBr pellets. The product analysis was made using the nuclear magnetic resonance spectroscopy (NMR 300 MHz, Bruker AVANCE III BBO Probe) and ultraviolet-visible absorbance spectroscopy (UV-vis spectrophotometer, SHIMADZU UV-2600). X-ray absorption spectroscopy (XAS) was conducted in a transmission mode at beamline X-ray absorption fine structure for catalysis (XAFCA) of Singapore Synchrotron Light Source. The XAS-related data processing was performed using Athena and Artemis software packages. Extended X-ray absorption fine structure (EXAFS) fittings were performed with Artemis in R-space. The coordination parameters of samples were obtained by fitting the experimental peaks with theoretical amplitude. The quantitative curve-fittings for all samples were conducted with R range of 1-3 Å and k range of 2-13 Å⁻¹. The backscattering amplitude F(k) and phase shift Φ(k) were calculated by FEFF6.0 code. As for the curve-fitting, all the amplitude reduction factor S₀² was set to the best-fit value of 0.92 determined from fitting the data of copper foil by fixing coordination numbers as the known crystallographic value.

### DFT Calculations

DFT calculations based on CASTEP packages had been introduced to investigate the electronic modulations induced by the tpp molecules in RhCu M. In particular, the generalized gradient approximation (GGA) and Perdew-Burke-Ernzerhof (PBE) functionals were applied to deal with the exchange-correlation interactions. The ultrasoft pseudopotentials had been selected and the corresponding plane-wave basis cutoff energy was set to 440 eV with an ultrafine quality. The Broyden-Fletcher-Goldfarb-Shannon (BFGS) algorithm was applied with a coarse quality of k-point settings with a separation of 0.7 1/Å in the present invention for all the energy minimizations. The following convergence criteria were applied for all the geometry optimizations, where the Hellmann-Feynman forces should be smaller than 1×10⁻³ eV/Å and the total energy difference should be converged to smaller than 5×10⁻⁵ eV/atom.

### Theoretical Calculations

To construct the crystalline part of RhCu M, the (110) surface was cleaved from the Rh unit cell with 6 atomic layers, where the thickness was less than 1 nm to match the experiments. 25% of the Rh sites had been replaced with Cu atoms to match the atomic ratio of 3:1. For the amorphous part of RhCu M, molecular dynamic (MD) simulations were conducted under 1200 K for 5 ps with 1 fs for each step. The MD simulations were carried out under the NVT condition with constant temperature and volume. The RhCu M was constructed by half crystalline part and half amorphous part with 120 atoms (Rh₉₀Cu₃₀) in total. Considering the large size of the tpp molecule, only the building unit of tpp was introduced on the interface within RhCu M. A vacuum space of 20 Å along the z-axis direction was also introduced to guarantee sufficient space during the relaxation process.

### Example 2

### Synthesis of Heterophase RhCu M-Tpp Nanostructures

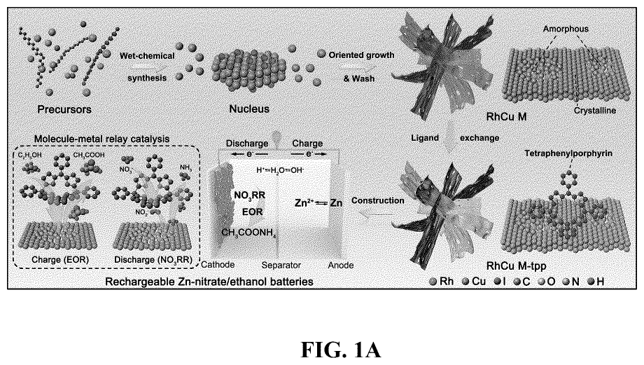

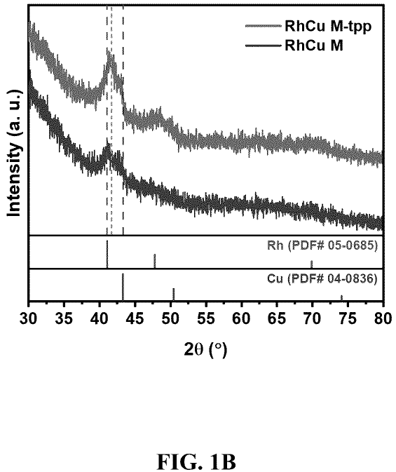

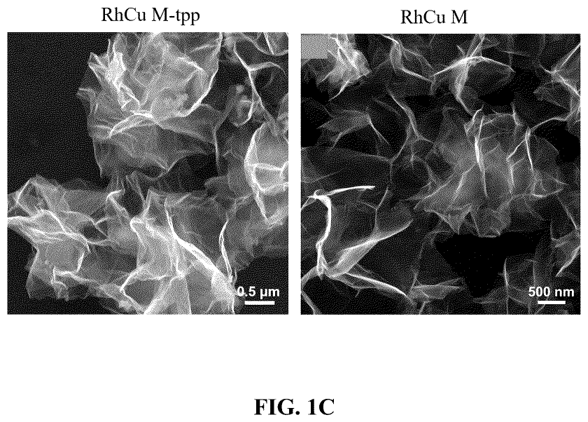

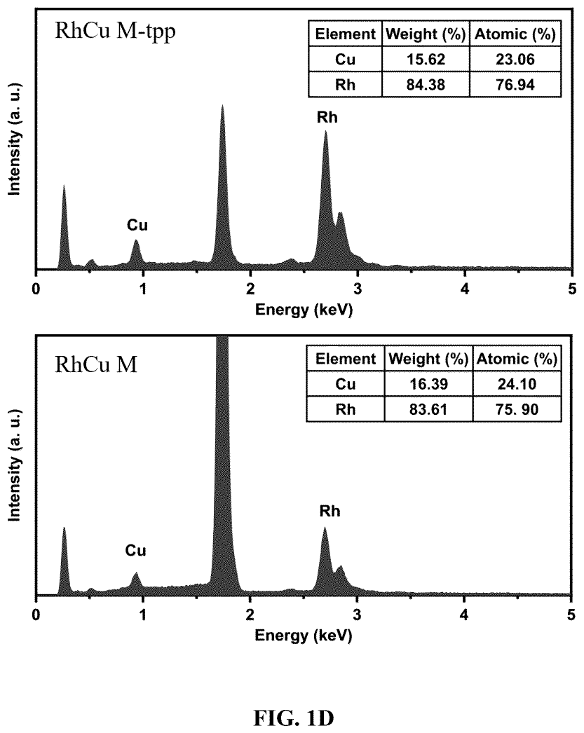

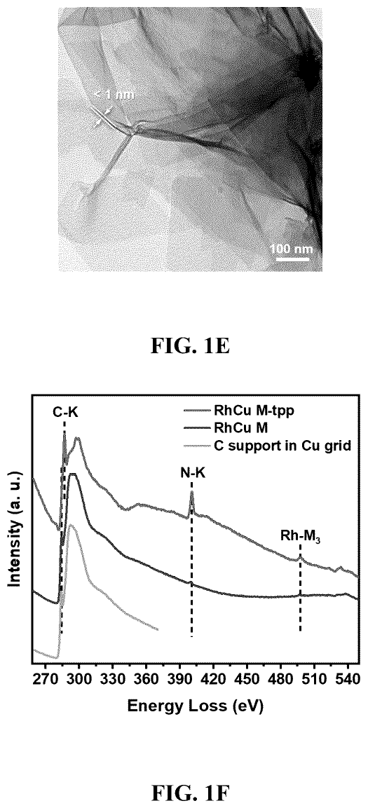

The invention provided a facile one-pot wet-chemical growth method that utilizes commercially available chemicals and easily accessible equipment. The synthesis process of RhCu M-tpp was illustrated schematically in FIG. 1A. The synthetic routine could be divided into two steps. The slow co-reduction of Rh and Cu precursors in oleylamine, aided by reductants and surfactants, led to the formation of ultrathin amorphous/crystalline RhCu bimetallic metallenes (RhCu M). In the subsequent step, the as-obtained RhCu M was subjected to ligand exchange in chloroform dissolved with tpp molecules. The phase composition, morphology, and size of RhCu M-tpp could be controlled by regulating the reaction temperature and the feeding ratio of Rh/Cu precursors. All the starting chemicals were available from commercial companies.

In a typical synthetic protocol for amorphous/crystalline RhCu M, 3200 μL of OAm, 800 μL of Rh(acac)₃ solution (5 mM, in OAm) and 400 μL of KI solution (40 mM, in 1, 2-BDO) were firstly mixed together in a 20 mL glass vial and then stirred for 10 min. After that, 200 μL of Cu(acac)₂ solution (5 mM, in OAm) was added, and then stirred for another 10 min to ensure a homogenous and transparent solution, followed by the removal of magnetic stir bar. The sealed glass bottle was then subjected to heat-treatment in oil bath at 160° C. for 12 h. After cooling down to room temperature, the sediments were collected by centrifugation at 10000 rpm for 3 min and washed with the mixture of n-hexane and ethanol with a volume ratio of 1:1 for three times. The final RhCu M product was stored in n-hexane for further use.

In a typical ligand exchange process to prepare heterophase RhCu M-tpp, the as-obtained RhCu M was first sonicated for 10 minutes in chloroform and then collected by centrifugation at 10,000 rpm for 10 minutes. The above operation was repeated two times to ensure the good dispersion of RhCu M in chloroform. After that, 3 mg of RhCu M was dispersed in 10 mL of chloroform and sonicated for 5-10 min to generate a homogenous slurry. Then, 10 mg of tpp was added into the slurry and treated with sonification for another 5 min. The obtained slurry was subsequently transferred into a 12 mL sealed glass bottle and then stirred for 24 hours at room temperature. The sediments were collected by centrifugation at 10,000 rpm for 5 minutes, and the supernatant liquid was discarded. Finally, RhCu M-tpp could be obtained after washing the sediments with 10 ml of chloroform/ethanol (v/v=1/1) solution and centrifuging at 10000 rpm for 5 min for several times until the supernatant liquid became colourless.

Heterophase rhodium-copper metallene (RhCu M), rhodium-copper metallene (Rh M), and copper nanoparticles (Cu NPs) were also investigated to further compare their catalytic performances with the RhCu M-tpp.

In a typical synthesis of RhCu M, 3200 μL of oleylamine (OAm), 800 μL of Rh(acac)₃ solution (5 mM, in OAm), 400 μL of KI solution (40 mM, in 1, 2-BDO) and 200 μL of Cu(acac)₂ solution (5 mM, in OAm) were mixed together in a 20 mL glass vial and then stirred for 10 min. After that, the glass bottle was sealed and subjected to heat-treatment in oil bath at 160° C. for 12 h. After cooling down to room temperature, the sediments were collected and washed with the mixture of n-hexane and ethanol with a volume ratio of 1/1 for several times. The final product was stored in n-hexane for further use.

The Rh M was synthesized through the same procedure but without adding the Cu(acac)₂/OAm solution.

In a typical synthesis of Cu NPs, 10 mL of Cu(acac)₂ solution (10 mM, in OAm) and 1 mL of 1,2-BDO were added into a 12 mL glass bottle, followed by heat treatment in oil bail at 140° C. for 3 h. Then, Cu NPs could be obtained by centrifugation.

### Example 3

### Characterization of the RhCu M and Heterophase RhCu M-Tpp

XRD measurements were conducted on a Rigaku SmartLab SE X-ray diffractometer. Referring to FIG. 1B, the result showed that RhCu M existed as face-centered cubic (fcc) alloy. Following the tpp surface modification of RhCu M, RhCu M-tpp was prepared without any recognizable structural changes. The prepared RhCu M-tpp had a 2θ value of 41-42°. The weak and broad diffraction peaks also indicate the low-crystalline and ultrathin characteristics of the material.

SEM and Energy-dispersive X-ray spectroscopy (EDS) data were acquired by a Thermo Fisher Scientific (TFS) Quattro S scanning electron microscope. Referring to FIG. 1C, the SEM images showed that RhCu M-tpp exhibited a micrometer-sized self-assembly network, with interconnected 2D ultrathin flexible RhCu M-tpp nanosheets. Wrinkles were easily observed on their surface, resembling the structure of graphene. The EDS data revealed that the corresponding Rh/Cu atomic ratio is nearly 77/23 (FIG. 1D). The above observation was similar to that of RhCu M, suggesting that the tpp modification has a negligible influence on the morphology and composition of the RhCu metallene.

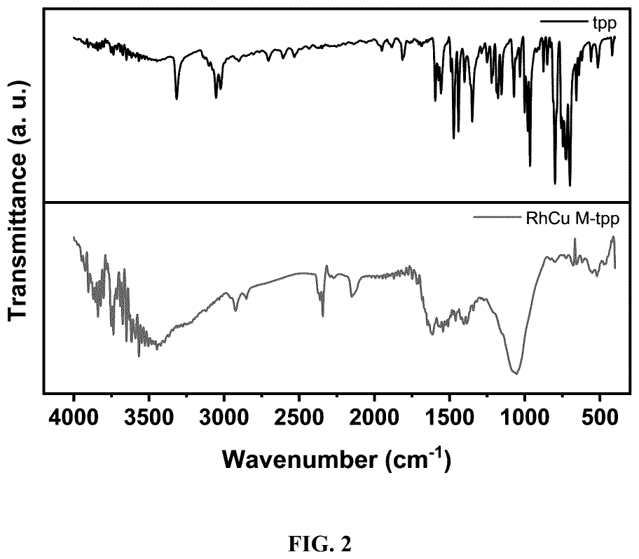

Furthermore, the detailed microstructures were investigated by transmission electron microscopy (TEM) and aberration-corrected high-angle annular dark-field scanning TEM (HAADF-STEM). TEM images and Electron energy loss spectroscopy (EELS) spectra were collected on a field emission JEM-2100F (JEOL, Japan). The HAADF-STEM images and EDS elemental mappings were obtained on a double aberration-corrected Spectra 300 TEM/STEM equipped with a Super-X EDS spectrometer (TFS, USA). Turning to FIG. 1E, the low contrast between the nanosheets and the carbon support indicated the few-layer nature of RhCu M-tpp. The lateral size of the nanosheets was in the range of hundreds of nanometers, while the thickness was below 1 nm, resulting in abundant low-coordination active sites exposed on the surface. As shown in FIG. 1F, the EELS spectra revealed that RhCu M-tpp demonstrated a sharp increase in N signal and a distinct near-edge fine structure of C—K when compared to RhCu M. These characteristic signals originated from the tpp molecules on the surface of RhCu M-tpp, which differ from the C signal detected in RhCu M due to the carbon coating on the Cu grid and the N signal originating from oleylamine. These observations confirmed the presence of tpp molecules on the surface of RhCu M-tpp, a finding further supported by Fourier transform infrared spectroscopy (FT-IR) (FIG. 2).

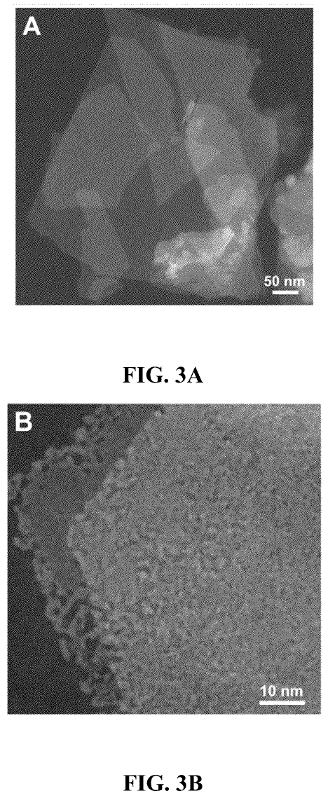

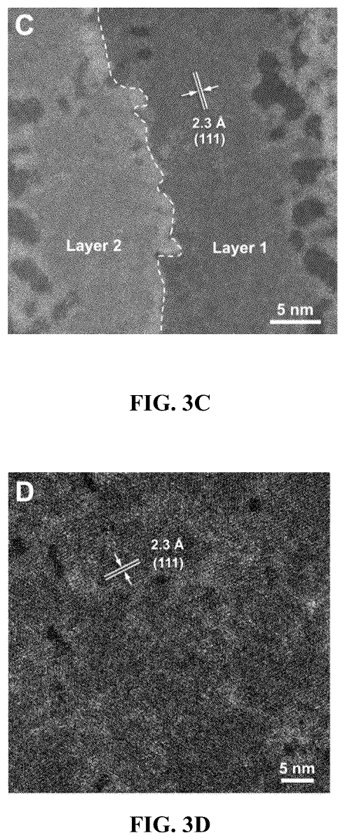

Additionally, low-magnification and low-dose HAADF-STEM images revealed that the in-plane 2D alloy structure was rich in pits and holes, with diameters ranging from 2 to 5 nm (FIGS. 3A-3D). A low-dose imaging mode was adopted to minimize the electron beam damage effect.

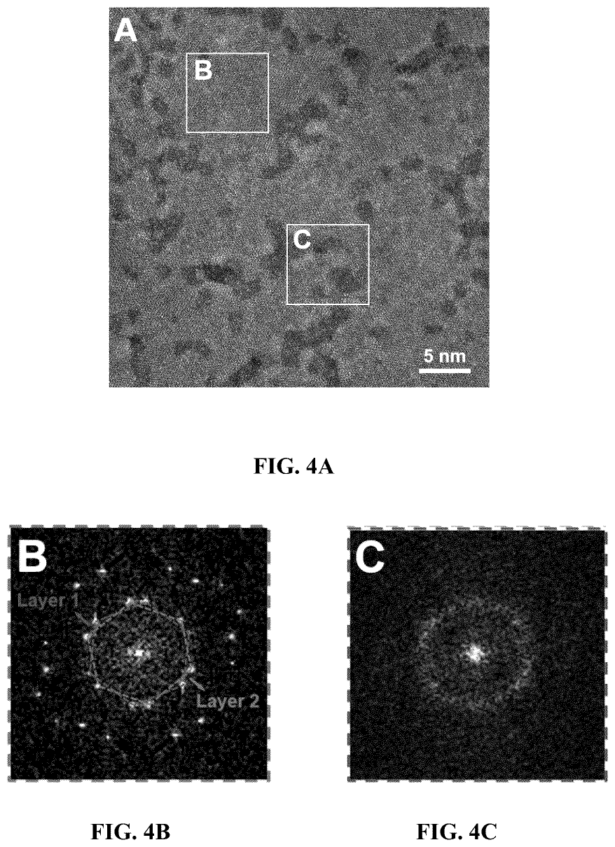

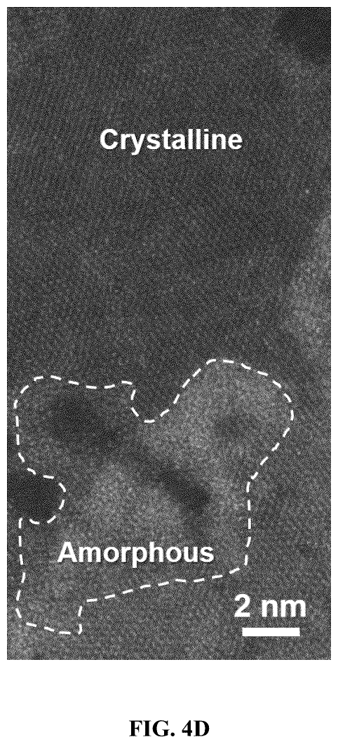

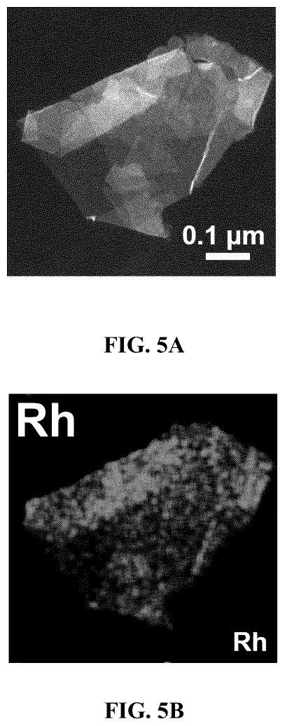

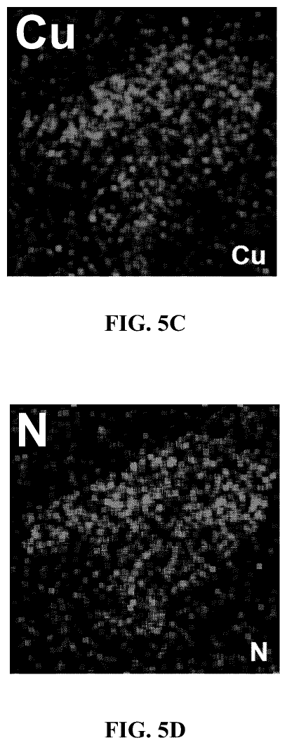

In FIGS. 4A-4D, the RhCu M-tpp exhibited a heterophase structure consisting of crystalline and amorphous domains. This structure was further confirmed by selected-area fast Fourier transform (FFT) patterns. Referring to FIGS. 5A-5D, both the HAADF-STEM images and corresponding EDS elemental mappings displayed a uniform distribution of Rh, Cu and N. Similar pits and holes, along with amorphous/crystalline domains, were also observed in the pristine RhCu M and Rh M.

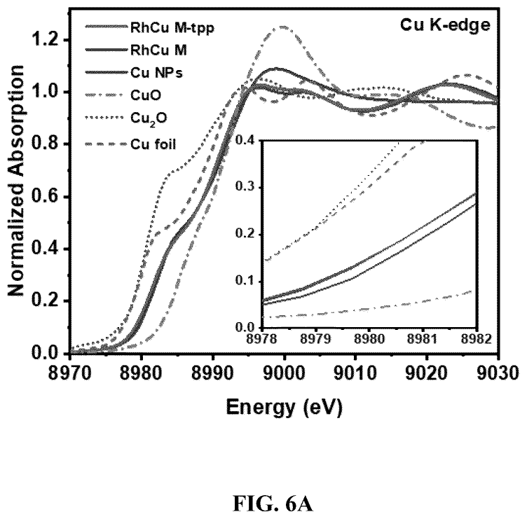

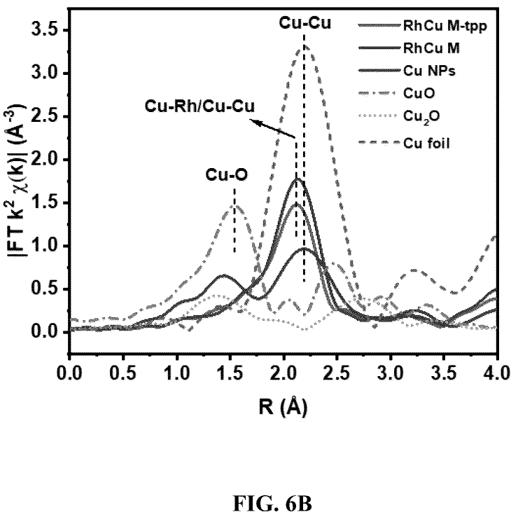

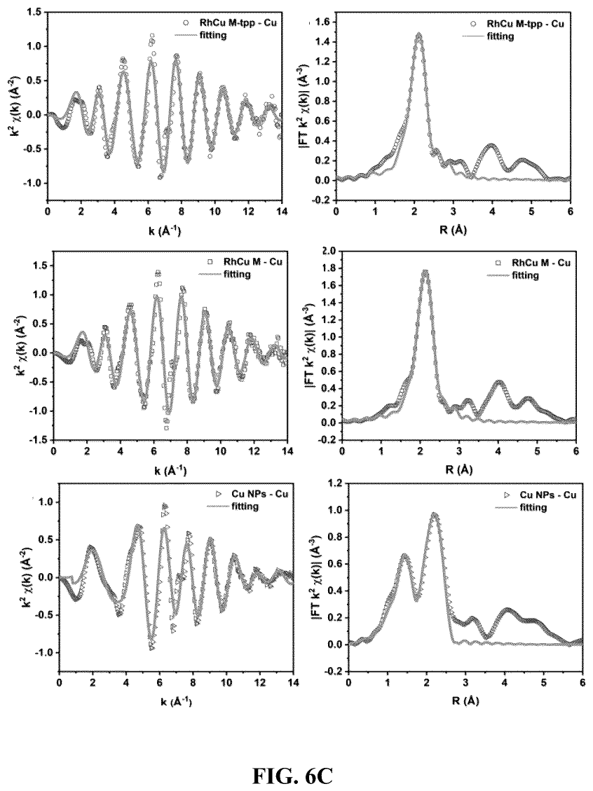

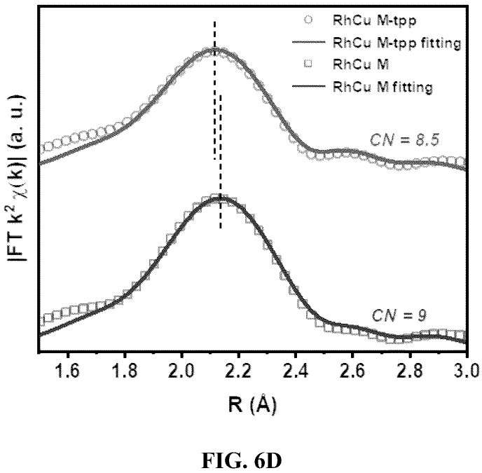

The electronic structure and coordination environment of as-obtained metallenes were further studied with X-ray absorption near-edge structure (XANES) and extended X-ray absorption fine structure (EXAFS) spectroscopies. As shown in FIG. 6A, the XANES spectra of RhCu M-tpp and RhCu M at the Cu K-edge were similar, with their white line positions falling between those of Cu foil/Cu₂O and CuO. This suggests that Cu atoms act as electron donors in both alloy metallenes due to their weak electronegativity. In contrast, the synthesized Cu NPs displayed the white line position at a slightly higher energy region than RhCu M and RhCu M-tpp, which was likely caused by surface oxidation in air. FIGS. 6B-6C showed that the Fourier transforms of EXAFS spectra were conducted to obtain the local coordination environments of Cu.

Referring to FIG. 6D, unlike the dominant peaks at approximately 2.18 Å ascribed to the Cu—Cu scattering path of Cu NPs and Cu foil in R space, both RhCu M-tpp and RhCu M showed their dominant peaks at approximately 2.11 Å, corresponding to the Cu—Cu and/or Cu—Rh scattering paths of the first shell. This change in the metal-metal bond length indicated the formation of RhCu alloy. After tpp modification, there was a slight variation on Cu—Cu and Cu—Rh bond lengths, but it did not affect the coordination number (CN) of Cu atoms obviously in RhCu M (=9) and RhCu M-tpp (=8.5). Table 1 lists fitting results of Cu K-edge EXAFS spectra for RhCu M-tpp, RhCu M, Cu NPs and Cu foil.

TABLE 1

| Samples | Path | CN | σ² (Å²) | ΔE₀ (eV) | R (Å) | R-factor |
|---|---|---|---|---|---|---|
| RhCu M-tpp | Cu—Rh | 2.8 (0.6) | 0.0090 (0.0019) | −0.97 (1.06) | 2.61 (0.02) | 0.021 |
| | Cu—Cu | 5.7 (0.9) | 0.0090 (0.0019) | −0.97 (1.06) | 2.56 (0.01) | |
| RhCu M | Cu—Rh | 2.5 (0.5) | 0.0086 (0.0015) | −0.98 (0.87) | 2.60 (0.02) | 0.012 |
| | Cu—Cu | 6.5 (0.8) | 0.0086 (0.0015) | −0.98 (0.87) | 2.55 (0.01) | |
| Cu NPs | Cu—O | 1.0 (0.2) | 0.0028 (0.0009) | 2.36 (2.52) | 1.87 (0.02) | 0.016 |
| Cu foil | Cu—Cu | 3.3 (0.7) | 0.0086 (0.0018) | −2.09 (2.01) | 2.53 (0.01) | 0.001 |
| | Cu—Cu | 12 | 0.0086 (0.0002) | −0.90(0.33) | 2.54 (0.002) | |

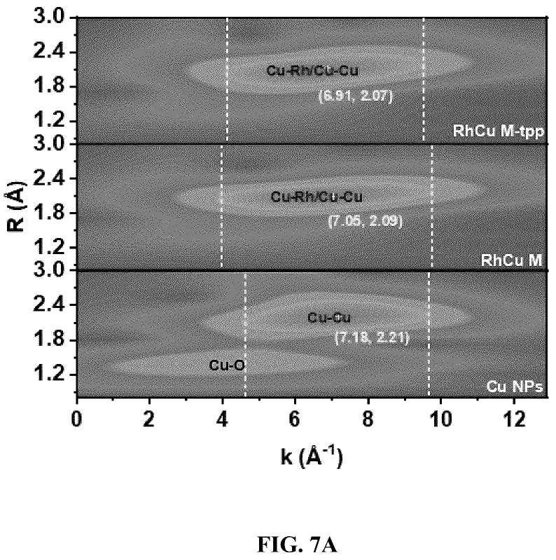

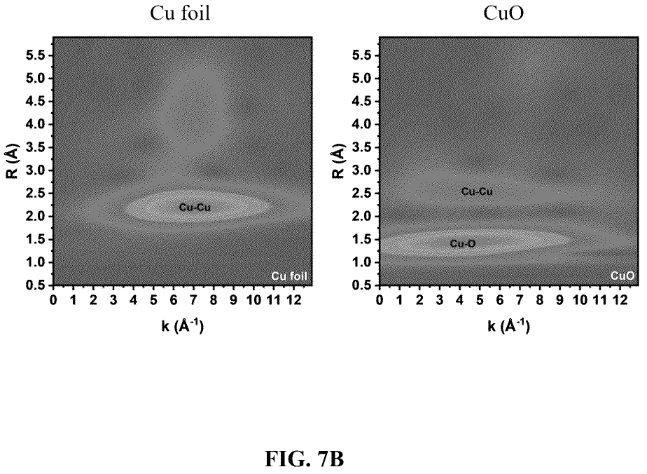

Turning to FIGS. 7A-7B, RhCu M-tpp and RhCu M demonstrated similar patterns of wavelet transform (WT) of Cu K-edge EXAFS spectra, which were different from that of Cu NPs, Cu foil and CuO. Compared with RhCu M, the center of maximum intensity for RhCu M-tpp showed a slight decrease in both k and R ranges. “k” refers to the range of wave numbers (k), typically used to describe the features of EXAFS; “R” refers to the range of distances, used to describe the distances between atoms in real space. Meanwhile, the distribution of maximum intensity for RhCu M-tpp was narrower in k range than RhCu M. These results indicated that tpp modification leaded to a certain variation in the coordination structure of RhCu M.

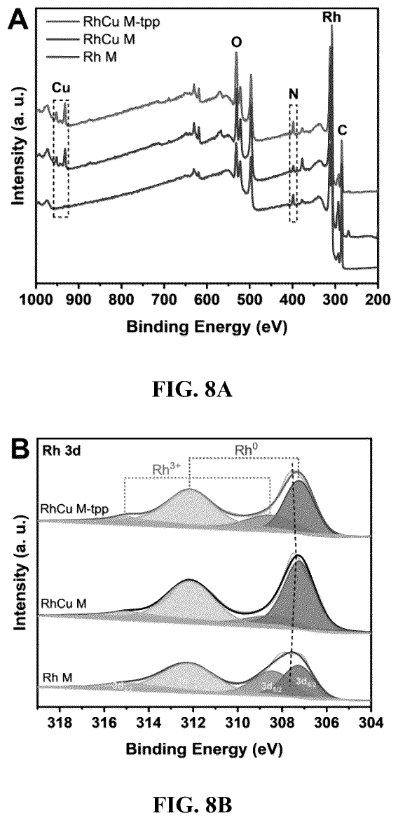

To further clarify the chemical states of heterophase RhCu M-tpp, X-ray photoelectron spectroscopy (XPS) was performed. XPS analysis was based on a ESCALAB 220i-XL electron spectrometer from VG Scientific using 300 W Al KR radiation (base pressure <10⁻⁵ mbar). It was evident that the Rh metallic state dominated in all synthesized metallenes. However, both RhCu M-tpp and RhCu M exhibited a much lower proportion of Rh³⁺ compared to Rh M (FIG. 8B).

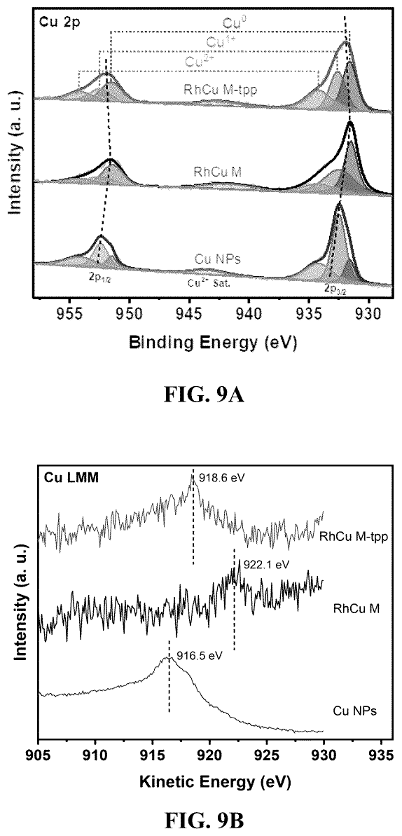

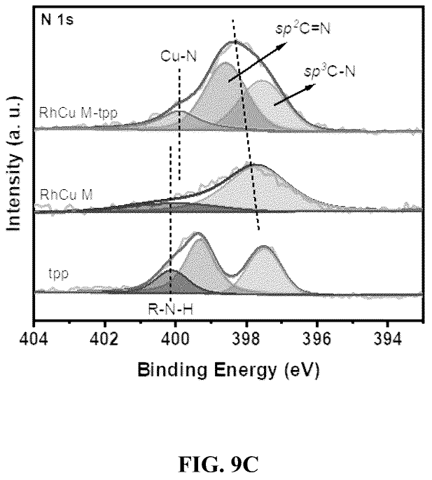

More pronounced changes in the valence states were observed in the high-resolution XPS spectra of Cu 2p. Two strong peaks located at 931.5 and 951.5 eV were attributed to the 2p_{1/2} and 2p_{3/2} doublet of metallic Cu⁰, while the other two weaker sets of double peaks at 932.5/952.4 eV and 934.2/954.1 eV represented the high-valence Cu⁺ and Cu²⁺ in RhCu M-tpp, respectively (FIG. 9A). Compared to pristine RhCu M, tpp modification induced a slight increase in the Cu valence, which can be attributed to electron transfer from Cu in RhCu to N in tpp. The Cu LMM Auger electron spectroscopy (AES) characterization further confirmed this change in valence state (FIG. 9B). Such strong electron coupling was identified as Cu—N bonds, as evidenced by the characteristic peak detected at 399.9 eV in the N is XPS spectrum (FIG. 9C). Simultaneously, the appearance of sp²-hybridized C atoms (C=N bonds) at around 398.6 eV further corroborated the existence of tpp in the obtained RhCu M-tpp.

### Example 4

### NO₃RR and EOR Performance of RhCu M-Tpp

The synthesized RhCu M-tpp catalysts exhibited potential applications in both electrocatalytic nitrate reduction to NH₃ and electrocatalytic alcohol oxidation. Specifically, a carbon paper plate (1×1 cm, Toray H-060) was utilized to load the mixture of RhCu M-tpp and Nafion (binder) at a catalyst:binder weight ratio of 5:1 without the introduction of any carbon conductors. A certain amount of isopropanol was utilized as the solvent to prepare the homogenous catalyst ink with a catalyst concentration of approximately 1 mg mL⁻¹ through sonication. The obtained catalyst ink was dropped onto the carbon paper plates (CP, 1×1 cm, Toray H-060) slowly and homogenously at ambient environment. The mass loadings were controlled within 0.4 to 0.5 mg cm⁻².

Linear sweep voltammetry (LSV) measurements were conducted in 0.5 M Na₂SO₄ aqueous solution in the absence/presence of 3000 ppm NaNO₃. The low concentration (approximately 48 mM) of NO₃⁻ in the neutral electrolyte is relatively close to the NO₃⁻ concentration found in industrial wastewater and also significantly reduces the CO₂ intake issue.

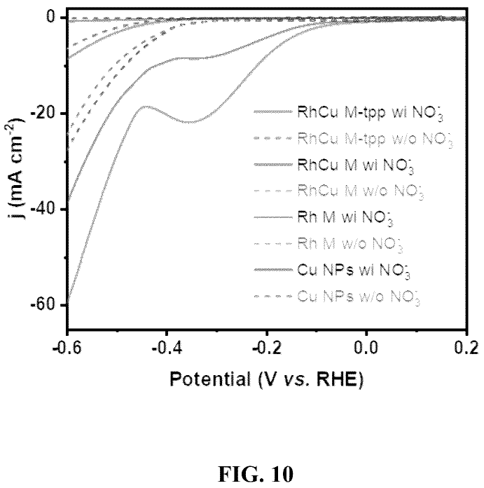

Referring to FIG. 10, both the heterophase RhCu M-tpp and RhCu M delivered much higher current densities after adding NO₃⁻ to the electrolyte. The peak current occurring at −0.2 to −0.4 V (vs. RHE) was attributed to the limited mass transfer. At this stage, both NO₃RR and hydrogen evolution reaction (HER) competed, but NO₃RR was expected to dominate. When the applied potential became more negative (<−0.4 V (vs. RHE)), the competing HER process dominated due to the strong hydrogen evolution capacity of Rh. In contrast, there was a relatively small discrepancy between the LSV curves of Rh M with and without NO₃⁻. Additionally, the synthesized Cu nanoparticles delivered only a small current over this potential window.

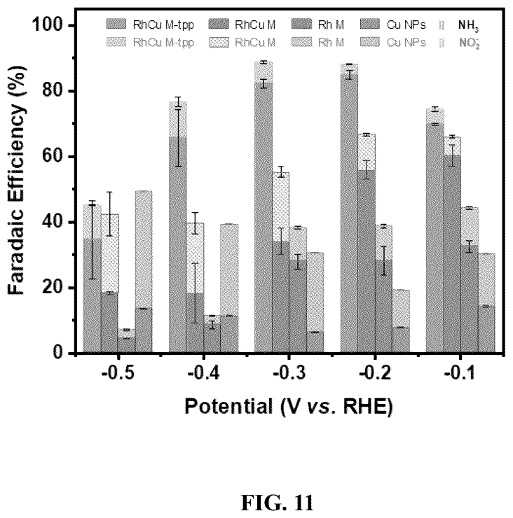

The products of NO₃RR were analyzed by colorimetric methods. FIG. 11 showed the FEs of NH₃ and NO₂⁻ for as-synthesized samples. RhCu M-tpp delivered the best performance over the whole potential window from −0.1 to −0.5 V (vs. RHE), and achieved excellent ammonia Faradaic efficiency (FE) of above 70% with potential above −0.4 V and the highest ammonia FE of 84.8% at −0.2 V (vs. RHE). Meanwhile, a small proportion of NO₂⁻ was also detected as the byproduct of NH₃ electrosynthesis, with the FEs ranging from 3.4% to 10.9%. Comparatively, RhCu M and Rh M demonstrated markedly lower catalytic selectivity towards NH₃ (FE<60.3% for RhCu M; FE<32.6% for Rh M) as the potential decreases, especially below −0.2 V relative to the RHE. For pure Cu NPs, NO₂ generation dominated the nitrate reduction process, but the total FEs of NH₃ and NO₂ remained at quite low levels under the same test conditions.

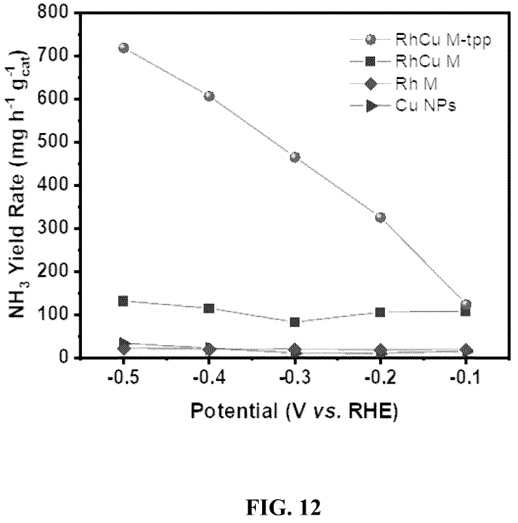

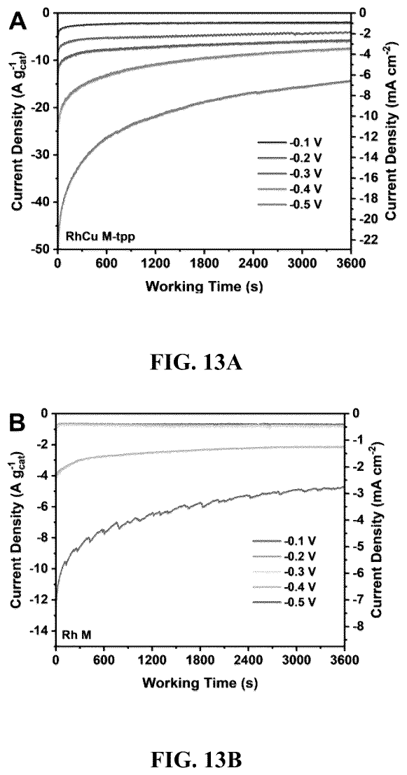

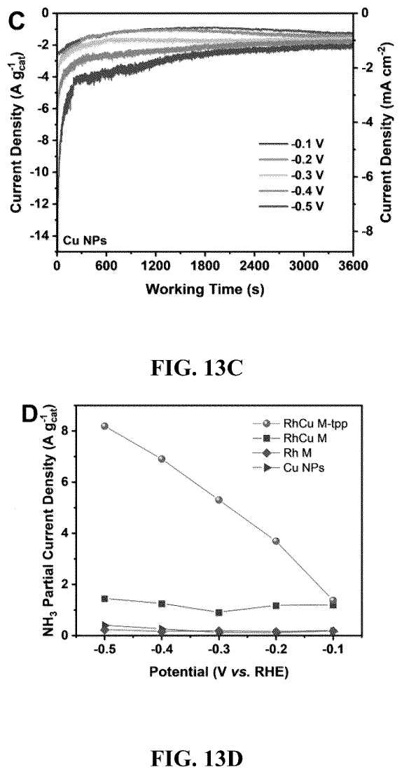

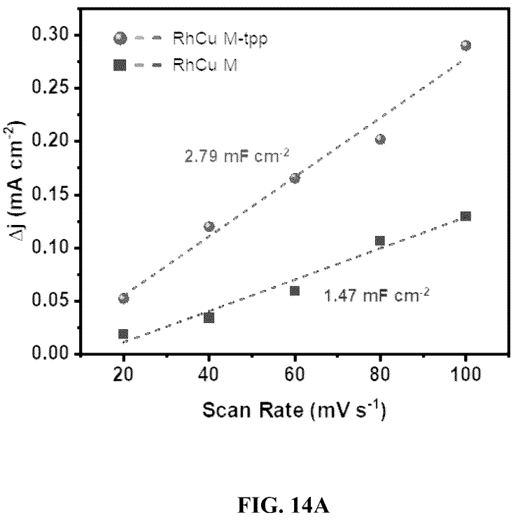

FIG. 12 demonstrated that the NH₃ yield rate of RhCu M-tpp continuously increased with the decrease of potential and reached the maximum point of 717.8 mg h⁻¹ g⁻¹_{cat}, which was almost 6 times higher than that of RhCu M. This observation implied the important role of tpp in boosting the NO₃⁻ reduction to NH₃ on RhCu metallenes. Simultaneously, the NH₃ yield rates of Rh M and Cu NPs were even much smaller (approximately 10-30 mg h⁻¹ g⁻¹_{cat}), primarily due to their much lower ammonia FEs and current densities (FIGS. 13A-13D). Only a few previous catalysts for NO₃RR have been capable of achieving such highly selective electrosynthesis of NH₃ at such low overpotentials under the same conditions.

### Example 5

### Effect of Tpp Modification on the Electrochemically Active Surface Areas of RhCu M-Tpp

To obtain electrochemical surface area (ECSA), CV measurements were performed at different sweep rates within the corresponding non-Faradaic intervals of different cathodes and a linear relation was demonstrated by fitting the function between current density differences (ΔJ, J_{anodic}−J_{cathodic}) at the midpoint of interval and scan rates. The slope of the linear relation was electrochemical double-layer capacitance (C_{dl}). Then ECSA could be obtained through the following equation:

$$ECSA = ( {C}_{d l} / {C}_{s} ) \times {S}_{E} ,$$

where Cₛ represents the specific capacitance (0.04 mF cm⁻²), and S_{E} represents the apparent area of electrode (1 cm²).

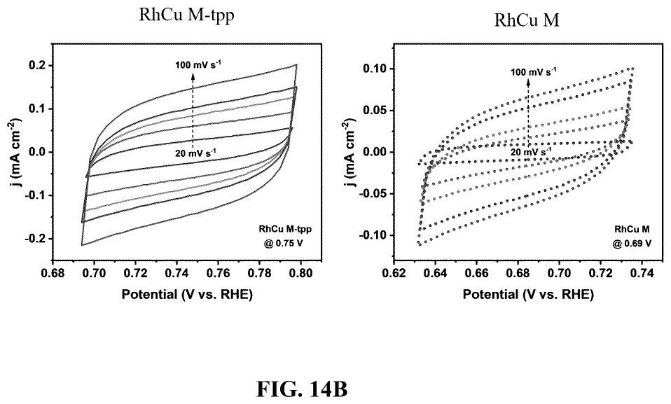

Turning to FIGS. 14A-14B, under the same mass loading, the RhCu M-tpp possessed a C_{dl} of 2.79 mF cm⁻², nearly twice than that of RhCu M (1.47 mF cm⁻²), suggesting that more in-plane alloy sites became active for NO3RR after being coupled with N atoms of tpp. This result partially explained the significantly higher NH₃ yield rate of RhCu M-tpp compared to RhCu M.

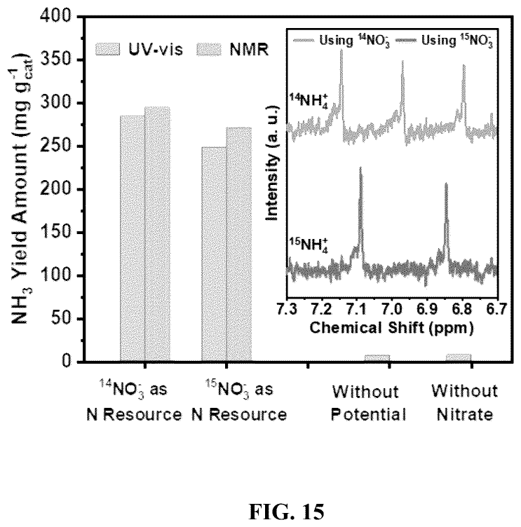

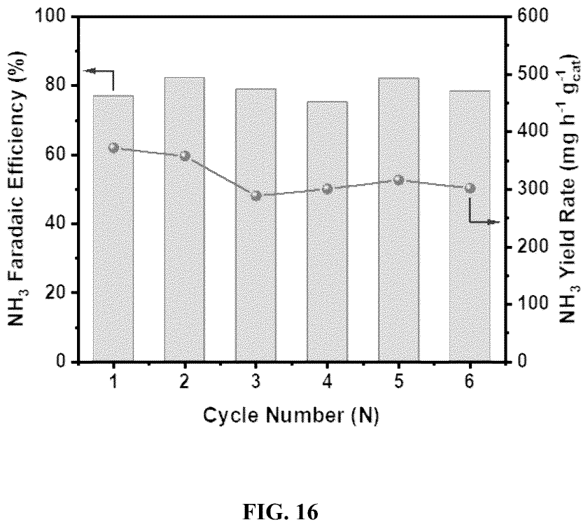

It is a known fact that tpp itself shows negligible catalytic activity towards NH₃ electrosynthesis. To confirm the origin of nitrogen in the synthesized NH₃, isotope labeling experiments were also conducted. As shown in FIGS. 15, the NH₃ yield amount in electrolytes after NO₃RR using ¹⁴NO₃⁻ or ¹⁵NO₃⁻ as the nitrogen resources was close to each other, as verified by both ¹H nuclear magnetic resonance (NMR) or ultraviolet-visible (UV-vis) absorption spectroscopies. In addition, the yield of NH₃ was negligible in cases where nitrate was not added or when no potential was applied. These results corroborated that the obtained NH₃ originated from the electroreduction of NO₃⁻. Furthermore, RhCu M-tpp also demonstrated good catalytic durability for NH₃ synthesis (FIG. 16). In addition, the morphology, structure and composition of RhCu M-tpp could be well maintained after the cycling stability test.

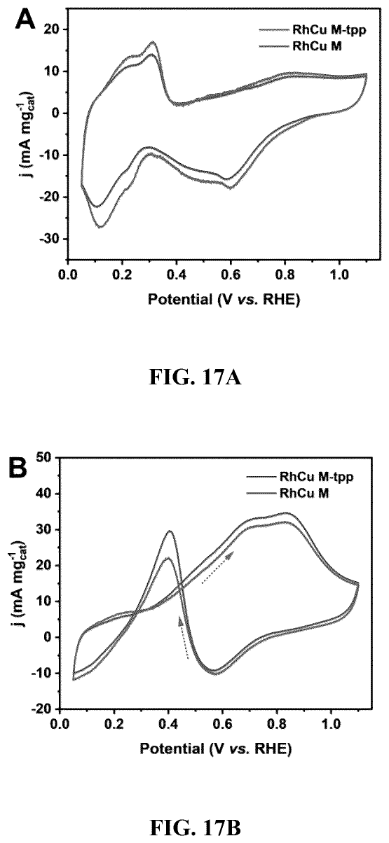

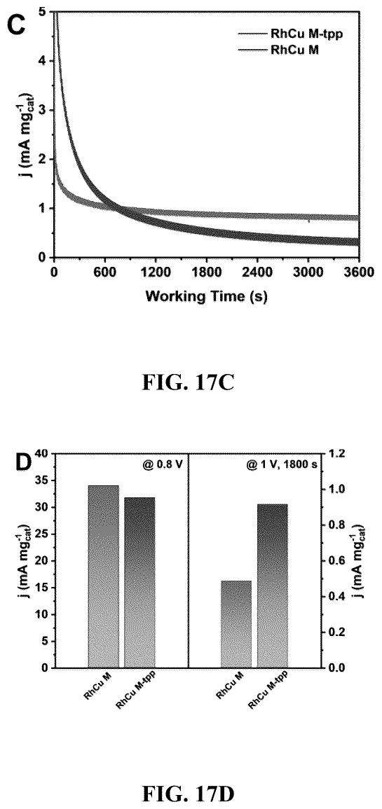

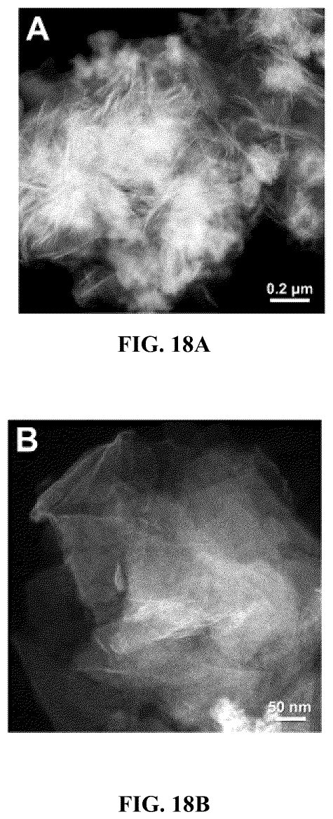

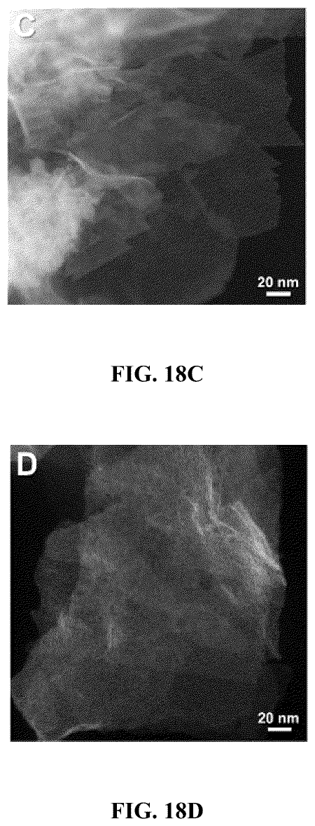

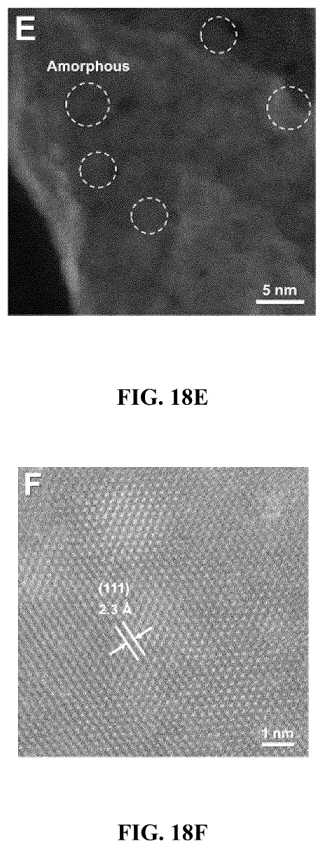

Since the formation of NH₃ led to a mildly alkaline environment in the electrolyte, the EOR performance of RhCu M-tpp cathodes was further assessed in a solution containing 1 M KOH and 1 M EtOH. Carbon paper-supported RhCu M-tpp cathodes were directly employed for EOR measurements to simulate practical working conditions for NO₃RR. Referring to FIGS. 17A-17B, unlike the cyclic voltammetry (CV) profiles observed in KOH solution, both RhCu M-tpp and RhCu M exhibited two obvious ethanol oxidation peaks at 0.8 and 0.4 V (vs. RHE) in KOH/EtOH solution. The EOR peak currents were 34.0 and 31.8 mA mg⁻¹ for RhCu M and RhCu M-tpp. When conducting the chronoamperometric electrolysis at 1.0 V (vs. RHE), RhCu M-tpp demonstrated a much higher activity than RhCu M after long-term run, and the mass activities for RhCu M-tpp and RhCu M at different states were compared as well (FIG. 17C-17D). After EOR measurements, the majority of RhCu M-tpp maintained their holey and ultrathin nanostructures, with both crystalline and amorphous domains still co-existing.

Replacing ethanol (EtOH) with methanol (MeOH) or ethylene glycol (EG) resulted in similar effects, reducing the charge plateaus of assembled Zn-nitrate/MeOH and Zn-nitrate/EG batteries.

### Example 6

### Assembly of Zinc-Nitrate/Ethanol Batteries and Zn-Nitrate Galvanic Cells

Given the excellent electrocatalytic performance of heterophase RhCu M-tpp, a highly rechargeable and low-overpotential zinc-nitrate/ethanol battery could be constructed.

During the assembly of rechargeable Zn-nitrate/ethanol batteries, copper-based catalysts (1×1 cm) were used as the working electrodes (cathode), while polished Zn plates (2×2 cm) served as the both the reference and counter electrodes (anodes). The RhCu M-tpp cathode was further matched with Zn metal anode to assemble Zn-nitrate/ethanol batteries in bipolar membrane separated H-cells where 25 ml of 1 M KOH aqueous solution with 0.02 M Zn(CH₃COO)₂ as additive was used as the anolyte and 25 ml of 0.5 M Na₂SO₄/3000 ppm NO₃⁻ solution mixed with 1 M ethanol was used as catholyte.

The assembly of routine Zn-nitrate galvanic cells was similar to that of above rechargeable Zn-nitrate/ethanol batteries but only using 0.5 M Na₂SO₄/3000 ppm NO₃⁻ mixed solution as the cathodic electrolyte.

### Example 7

Electrochemical Performance of Zinc-Nitrate/Ethanol Batteries with RhCu M-Tpp

The galvanostatic discharge/charge measurements of these Zn-based hybridized batteries were carried out using LAND battery test systems (CT2001A, Wuhan LAND Co. LTD) under different conditions at room temperature. Discharge polarization profiles were obtained by conducting cathodic LSV from high open-circuit voltage (OCV) to 0.005 V (vs. Zn²⁺/Zn) and then the resultant power density curves could be figured out.

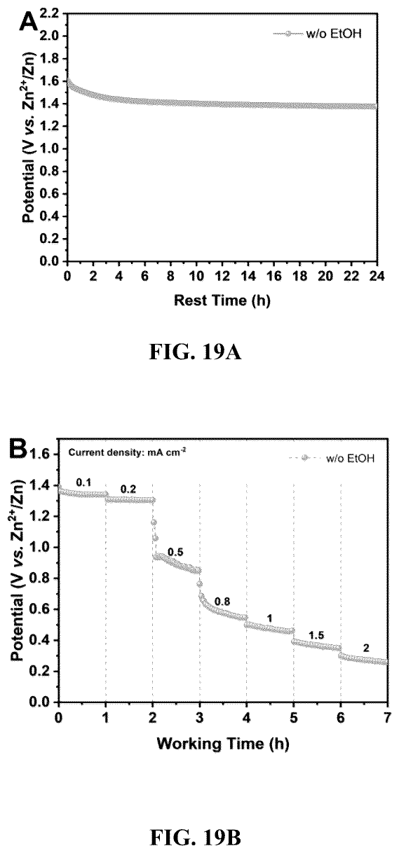

The assembled Zn—NO₃⁻ batteries exhibited OCV of approximately 1.4 V (vs. Zn²⁺/Zn), which remained stable during the subsequent 24-hour rest period (FIG. 19A). Meanwhile, the rate capability of the batteries could still run normally even when the current density reaches up to 2 mA cm⁻² (equal to about 5 A g⁻¹_{cat}) (FIG. 19B).

Another crucial technical hurdle facing Zn—NO₃⁻ batteries is their poor rechargeability. Due to the monofunctional design of most previous catalysts for NO3RR, the assembled Zn—NO₃⁻ batteries typically functioned as galvanic cells, resulting in the sacrifice of Zn plates. Refreshing anodic electrolytes and Zn anodes from encapsulated battery devices requires another complex production line, involving significant energy investment and tedious operation. This feature is detrimental to the deployment of Zn—NO₃⁻ batteries in grid-level energy storage or electric transportation facilities. To overcome this weakness, oxygen evolution reaction (OER) at cathodic side has been attempted to offer electrons for zinc deposition on anode. However, most catalysts with good electrocatalytic activity toward NO3RR are not suitable and stable for OER, making the batteries non-rechargeable or have a large charge plateau and quite limited cycling life. Meanwhile, it is not energy economical if the only beneficial point of OER is recharging the battery, and there could be several potential safety hazards like high pressure, fire and explosion in sealed power units due to the generated O₂ gas. Unfortunately, there still lacks effective bifunctional catalysts and electrochemical systems to construct high-performance, rechargeable and eco-friendly Zn—NO₃⁻ hybrid energy conversion and storage devices.

In contrast to commercial non-rechargeable Zn—NO₃⁻ batteries that require a high charge potential to drive oxygen evolution reaction for recharging, in the present invention, Rh in RhCu M-tpp not only facilitates proton enrichment around Cu sites in NO₃RR (discharge process), but also serves as an active site towards EOR (charge process) to provide electrons for reversible Zn planting on the anode.

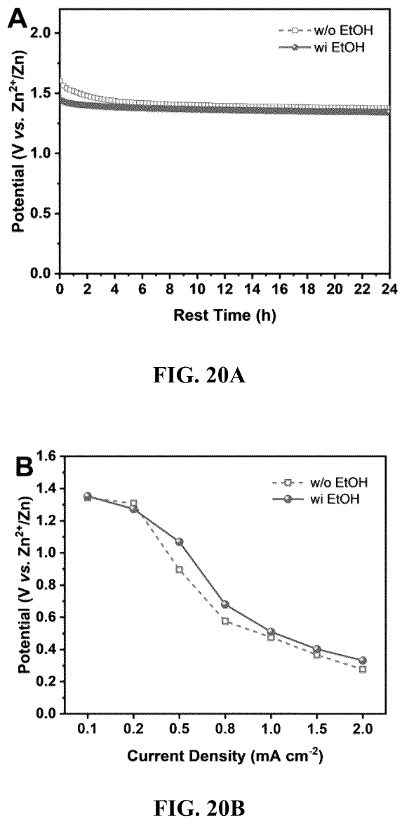

The EOR offers greater energy efficiency for metal-NO₃⁻ batteries than oxygen evolution reaction, as evidenced by lower overpotentials, desirable products, and extended lifespan. The mixed solution containing 0.5 M Na₂SO₄, 3000 ppm NaNO₃ and 1 M ethanol was applied as the catholyte. Referring to FIGS. 20A-20B, adding the ethanol did not affect the electrochemical behaviors of catalysts in NO₃RR, according to the OCV and rate performance of as-assembled Zn-nitrate/ethanol batteries.

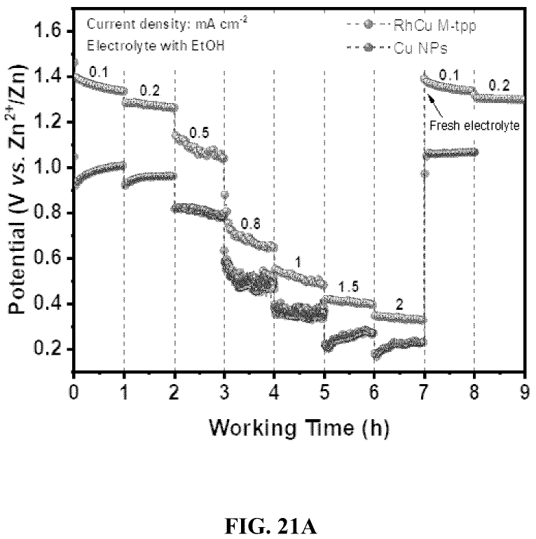

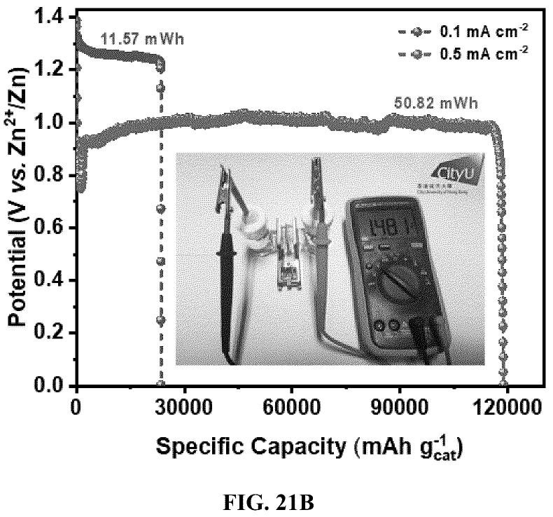

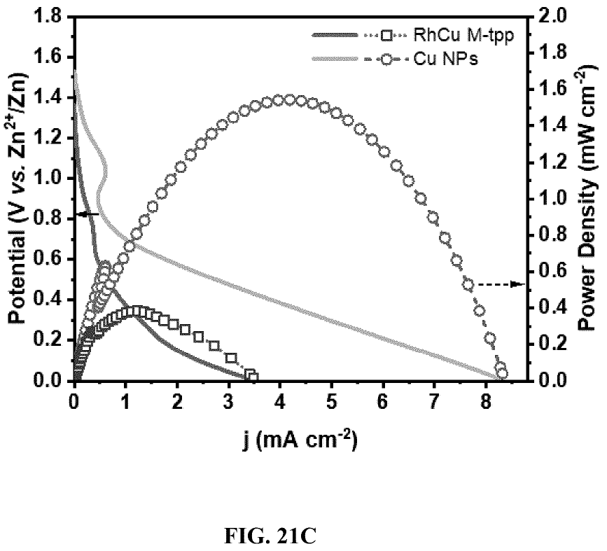

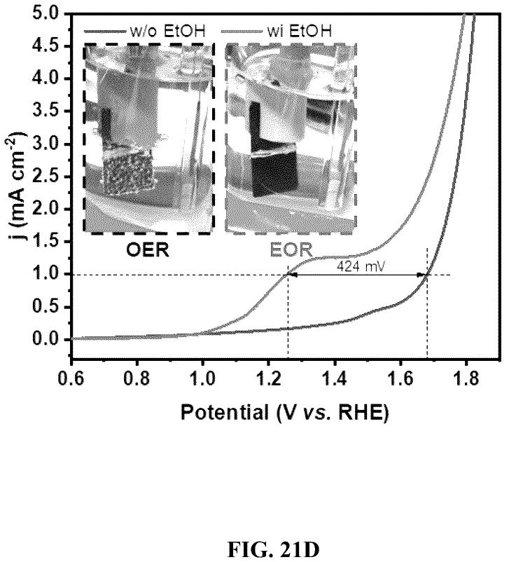

The apparent performance of Cu nanoparticles primarily originates from reactions that produce NO₂⁻ and self-reduction, rather than the formation of NH₃. FIG. 21A showed the rate performance of heterophase RhCu M-tpp and Cu NP cathodes during discharging. The discharge plateaus were about 1.36, 1.28, 1.07, 0.69, 0.52, 0.41 and 0.34 V (vs. Zn²⁺/Zn) at 0.1, 0.2, 0.5, 0.8, 1.0, 1.5 and 2.0 mA cm⁻² for RhCu M-tpp, respectively, which were significantly higher than those of Cu NPs. When the battery resumed operation at low rates, its working voltage returned to its original state, indicating the excellent tolerance of RhCu M-tpp to high current impact.

Referring to FIG. 21B, the constructed Zn-nitrate/ethanol batteries with RhCu M-tpp released an outstanding electric energy of 50.82 mWh in total upon fully discharged to 0.005 V (vs. Zn²⁺/Zn) at 0.5 mA cm⁻², corresponding to a superior energy density of 117364.6 Wh kg⁻¹_{cat}. The discharge profile at a low rate of 0.1 mA cm⁻² was also provided for more comprehensive exhibition. Given the enhanced NO₃RR kinetics, Zn-nitrate/ethanol batteries with RhCu M-tpp achieved a maximum power density of 1.54 mW cm⁻², which is over 4 times higher than that of Cu NPs (0.38 mW cm⁻²) (FIG. 21C).

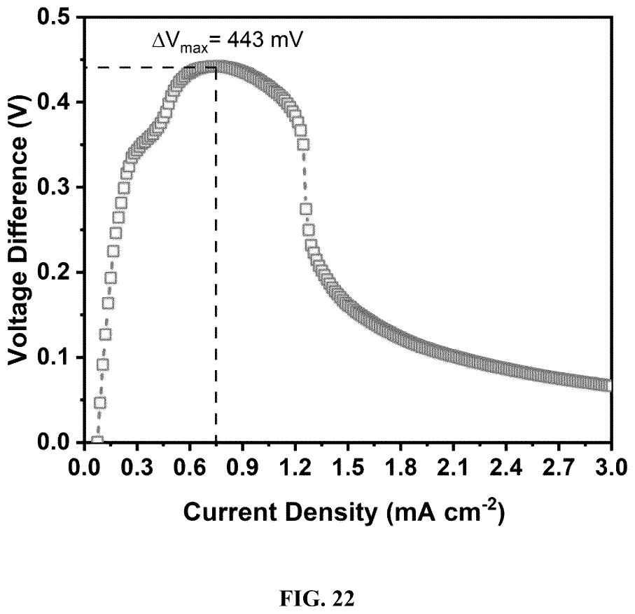

Furthermore, the cathodic LSV measurements were conducted from OCV to 1.85 V (vs. RHE) on RhCu M-tpp cathodes after 1 h NH₃ electrosynthesis in different electrolytes with or without ethanol. FIG. 21D showed that numerous bubbles formed on the cathode surface during linear scanning in the absence of ethanol, while there was no noticeable bubble formation on the other cathode surface in the solution containing ethanol. This indicates the occurrence of OER and EOR in the two different electrolytes, respectively. Simultaneously, the EOR exhibited much lower overpotential than the OER at the same current density on RhCu M-tpp cathodes. FIG. 22 showed that at a typical current density of 1 mA cm⁻² for battery operation, the voltage gap reached 424 mV, approaching the maximum value of 443 mV, which mean that the energy consumption would be greatly decreased when charging this battery with EOR rather than OER.

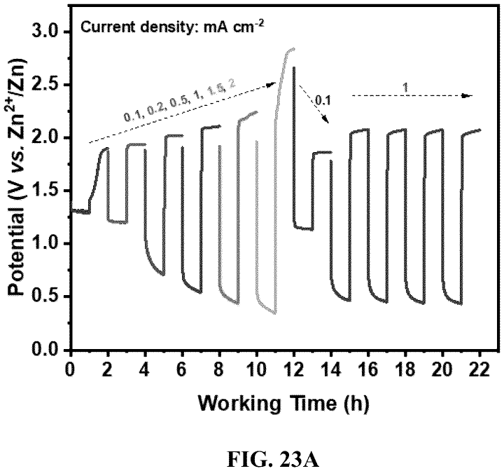

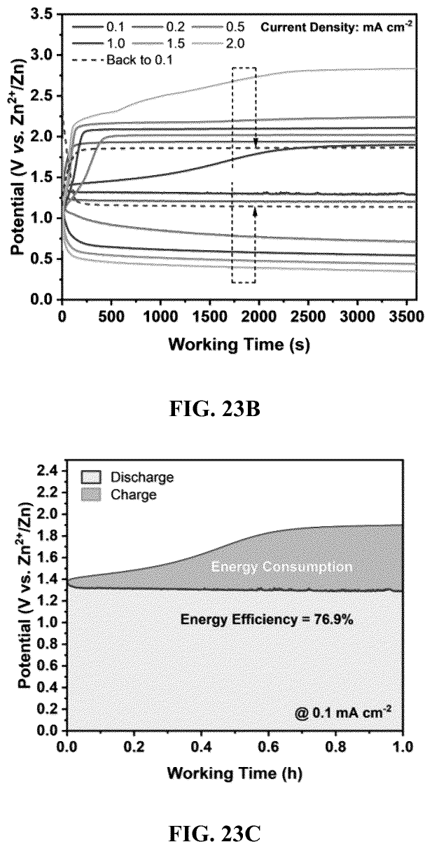

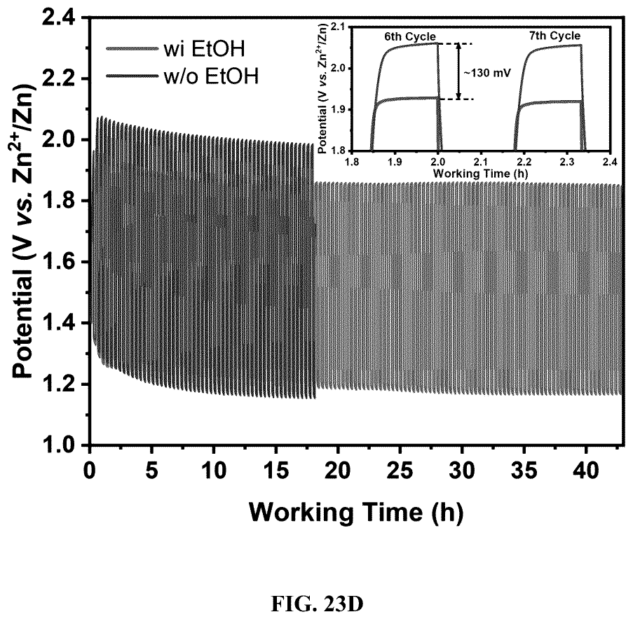

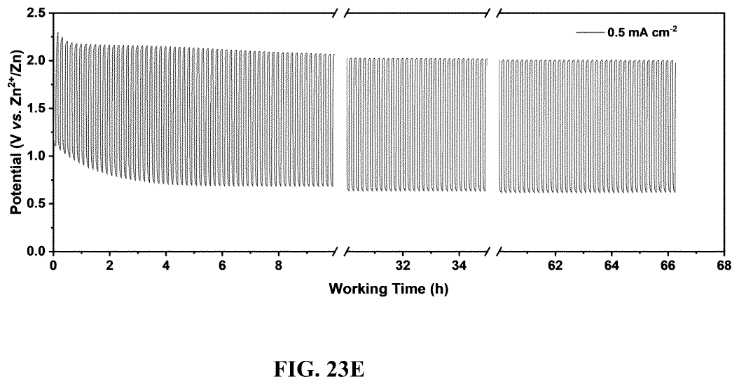

The Zn-nitrate/ethanol batteries were then consecutively discharged and recharged at various rates. As the current density increased from 0.1 to 2 mA cm⁻², the gradual voltage polarizations happened in both discharge and charge processes, and the battery voltage recovered after the current density returned to 0.1 mA cm⁻² and kept stable in the following cycles at 1 mA cm⁻², suggesting the good chemical and structural stability of RhCu M-tpp as a bifunctional catalyst (FIG. 23A). During the rate-capability measurements, the highest round-trip energy efficiency was 76.9% (FIGS. 23B-23C). In addition, the long-term cycling performance was also evaluated in different electrolytes.

Compared to the routine Zn—NO₃⁻ galvanic cells, the rechargeable Zn-nitrate/ethanol batteries showed a large charge plateau decrease by approximately 130 mV at 0.1 mA cm⁻² and kept normal function for above 40 h (FIG. 23D). Furthermore, it lasted steadily for at least 400 cycles when running at a higher rate of 0.5 mA cm⁻² (FIG. 23E).

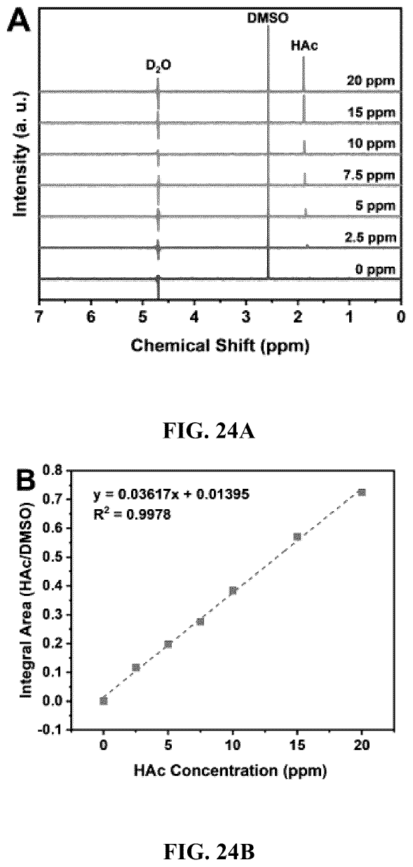

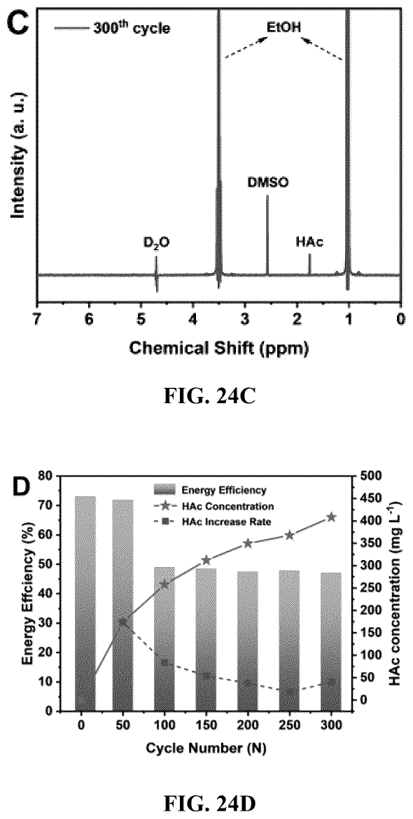

Referring to FIGS. 24A-24D, the changes in acetic acid (HAc) concentration in the cathodic electrolyte during cycling were further investigated using the 1H NMR quantification method. At the 50^{th}, 100^{th}, 150^{th}, 200^{th}, 250^{th} and 300^{th} cycles, the HAc concentrations are calculated to be 173.86, 257.70, 311.90, 349.52, 367.78 and 408.15 mg L⁻¹ in the electrolyte, respectively, according to the 1H NMR detection results. The corresponding energy efficiencies of the Znnitrate/ethanol batteries at the selected cycles are 71.88, 48.97, 48.47, 47.45, 47.85 and 47.17%, respectively. With the accumulation of cycles, the increase rate of HAc concentration decreased at every period of 50 cycles.

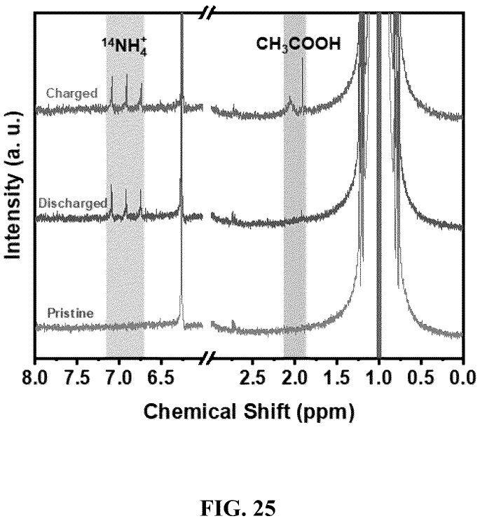

Moreover, as a combination of NO₃RR and EOR products, ammonium acetate, a widely used chemical in various important areas, can be generated in the cathodic electrolyte after the long-term run of Zn-nitrate/ethanol battery (FIG. 25).

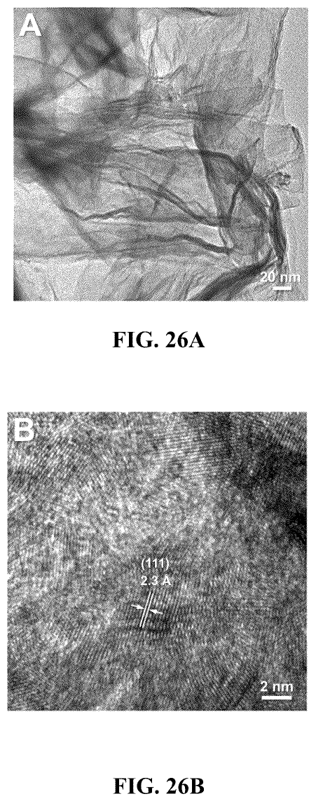

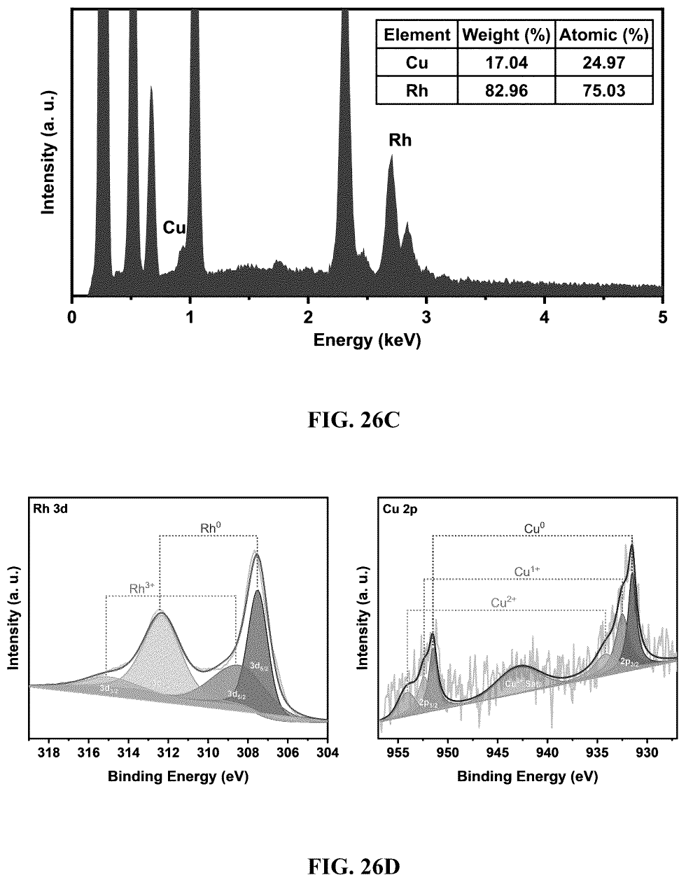

Referring to FIGS. 26A-26D, the TEM, EDS, and XPS characterizations showed that RhCu M-tpp maintained its microstructure and surface chemical state throughout the long-term round-trip NO₃RR-EOR cycles, even after passivation.

In general, apart from parasitic reactions such as HER and OER, the plausible working principles of the as-fabricated Zn-nitrate/ethanol batteries could be described as follows:
Anode: 4Zn+8OH⁻⇄4ZnO+4H₂O+8e⁻
Cathode NO₃⁻+7H₂O+8e⁻→NH₃·H₂O+9OH⁻ (Discharge)
   C₂H₅OH+4OH⁻→CH₃COOH+3H₂O+4e⁻ (Charge)
Overall reactions: 4Zn+NO₃⁺+3H₂O→4ZnO+NH₃·H₂O+OH⁻ (Discharge)
   4ZnO+2C₂H₅OH→4Zn+2CH₃COOH+2H₂O (Charge)
   NO₃⁻+2C₂H₅OH→CH₃COONH₄+CH₃COO⁻+H₂O (Cycle)

### Example 8

### Mechanism of Molecule-Metal Relay Catalysis

To gain deeper insights into the enhanced catalytic performance of heterophase RhCu M-tpp toward NH₃ electrosynthesis, systematic ex-/in-situ analysis and characterizations were carried out. Ex-/in-situ experimental studies and theoretical calculations reveal that there is a molecule-metal relay catalysis in NO₃RR over RhCu M-tpp that significantly facilitates the ammonia selectivity and reaction kinetics via a low energy barrier pathway.

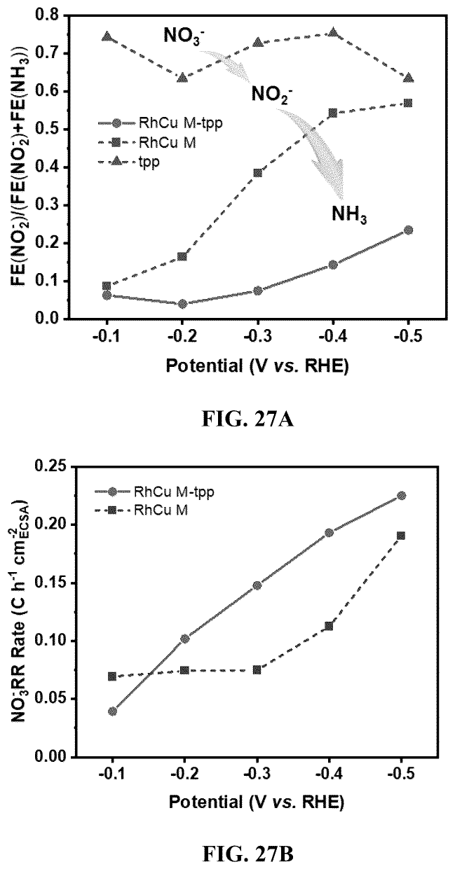

FIG. 27A showed that NO₂ ⁻ dominated the reduction products on pure tpp electrode, while the formation of NH₃ was greatly promoted on RhCu M electrode over the entire potential window of −0.1 to −0.5 V (vs. RHE). Significantly, the combination of tpp and RhCu alloying sites resulted in much higher selectivity for NH₃ generation on the RhCu M-tpp cathode compared to the RhCu M counterpart. Furthermore, even when the NO₃RR rates were normalized to ECSAs (FIG. 27B), RhCu M-tpp still exhibited much faster electron consumption to convert NO₃⁻ compared to RhCu M across a wide range of potentials. This indicated significantly enhanced reaction kinetics on individual active sites. The above results suggested that there was a molecule-metal relay catalysis between tpp and RhCu alloying sites, with a conversion sequence of:

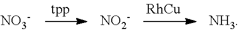

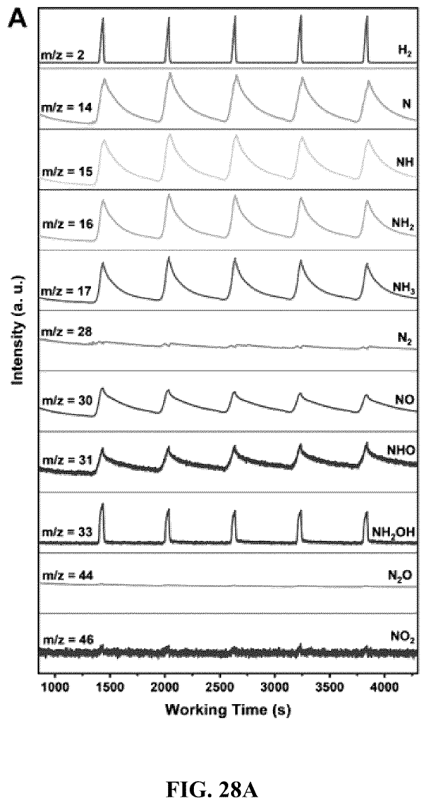

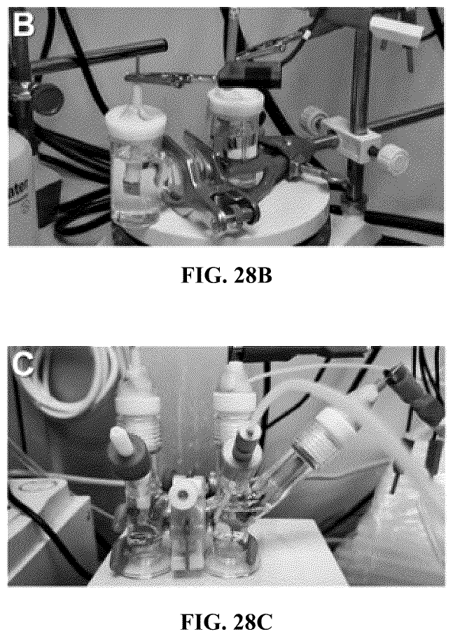

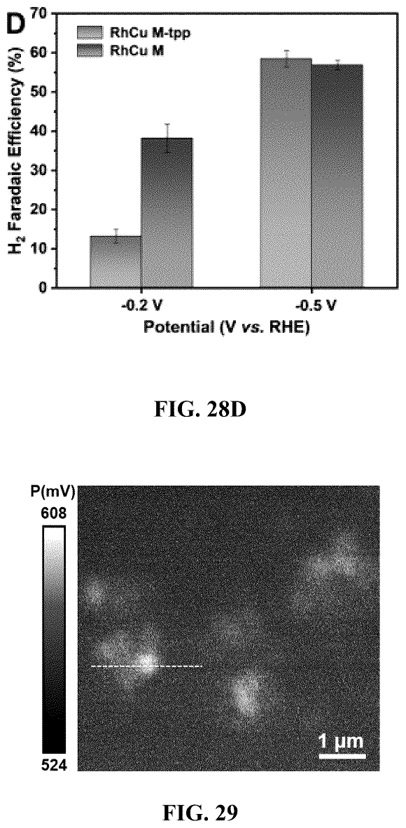

NO₃⁻ was firstly adsorbed and subsequently reduced to NO₂⁻ at a moderate reaction rate on tpp, and then NO₂⁻ diffused to Cu sites for the following rapid hydrogenation assisted by the surrounding Rh atoms toward NH₃ production. Meanwhile, based on the in-situ differential electrochemical mass spectrometry (DEMS) and H₂ quantification results (FIGS. 28A-28D), the presence of tpp molecules on the RuCu metallene surface could also help suppress the formation of H₂ (the primary gaseous side-product) around Rh centers under low-overpotential conditions.

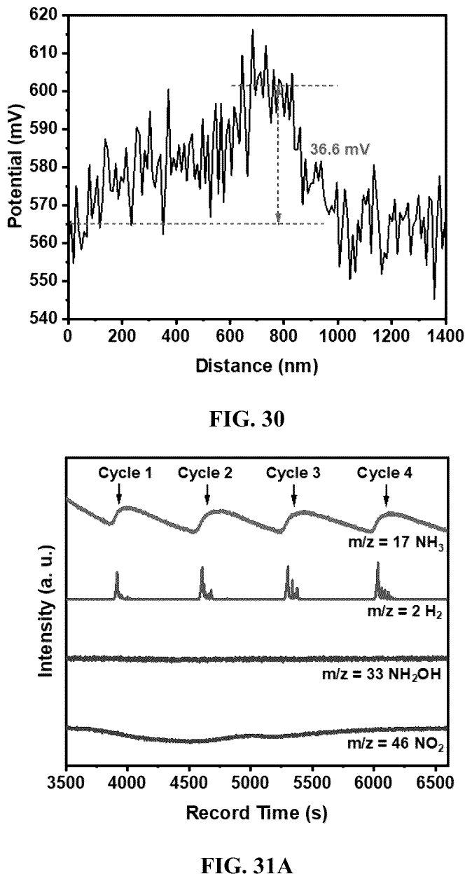

In FIG. 29, the Kelvin probe force microscopy (KPFM) characterization revealed the inhomogeneous potential distribution in the 3D assembly of as-synthesized RhCu M-tpp, where the metallene junctions delivered the higher potential than the in-plane nanosheets. According to the potential line scan of a typical metallene assembly, the potential gap was estimated to be around 36.6 mV (FIG. 30). Therefore, it could be inferred that multiple oriented electric fields were established, crossing from the junction to the nanosheet edge in each individual metallene under applied potentials. The gradient distribution of electric fields was capable of facilitating the ionic migration and the adsorption/desorption of intermediates on the catalyst surface, thereby promoting the reaction kinetics of NO₃RR.

### Example 9

### Electrochemical Mechanisms of NO₃RR and EOR of RhCu M-Tpp

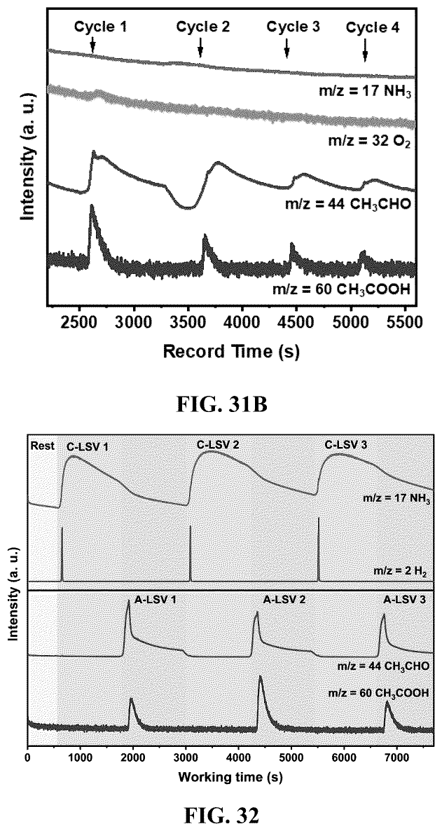

In this example, in-situ DEMS was utilized to clarify the reaction intermediates and products of Zn-nitrate/ethanol batteries. Referring to FIG. 31A, during four cathodic linear sweeps from 0 to −0.66 V (vs. RHE) at 6 mV s⁻¹, two different signals with mass-to-charge (m/z) ratios of 2 and 17 were detected as a function of reaction time. These signals corresponded to the formation of H₂ and NH₃ under negative potentials, respectively. Nevertheless, the signals of NH₂OH (m/z=33) and NO₂ (m/z=46) intermediates were not detected on the NO₃RR side. This absence could be attributed to the exceptionally rapid hydrogeneration process that occurred on this molecule-metal relay catalyst. At the EOR side, there was no obvious fluctuation on the NH₃ signal (FIG. 31B), suggesting that NH₃ could not be oxidized under the four times of anodic linear sweeping from 0.551 to 1.6 V (vs. RHE). This observation revealed the feasibility of the subsequent alcohol oxidation to produce ammonium acetate. A very little amount of Oz (n/z=32) was recognized only at the first cycle of LSV, indicating that EOR, rather than OER, was the dominant reaction while charging the battery. Acetaldehyde (CH₃CHO, m/z=44) and acetic acid (CH₃COOH, m/z=60) were also detected as the dominated intermediate and final product of the EOR.

Additionally, according to the in-situ DEMS results obtained during ordered cathodic and anodic linear scanning periods (FIG. 32), the OH⁻ generated in the former NO₃RR plays a significant role in maintaining the subsequent catalytic activity of RhCu M-tpp towards EOR during discharge-charge cycles⁶. The online round-trip monitoring results above thoroughly explained the detailed electrochemical reactions that occurred during the discharge and charge processes of the assembled Zn-nitrate/ethanol batteries.

### Example 10

### Computational Investigations

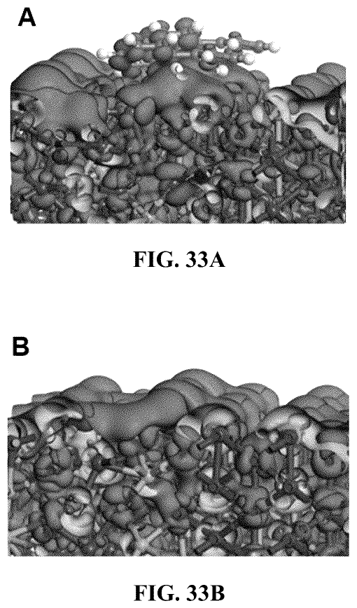

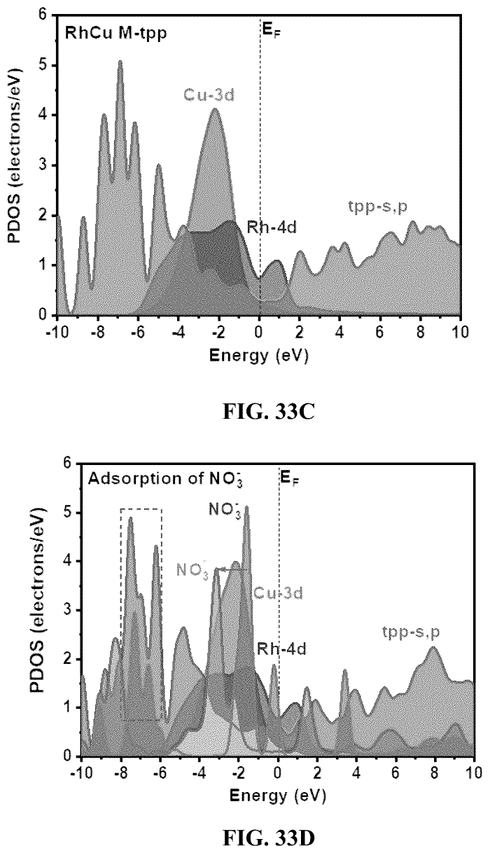

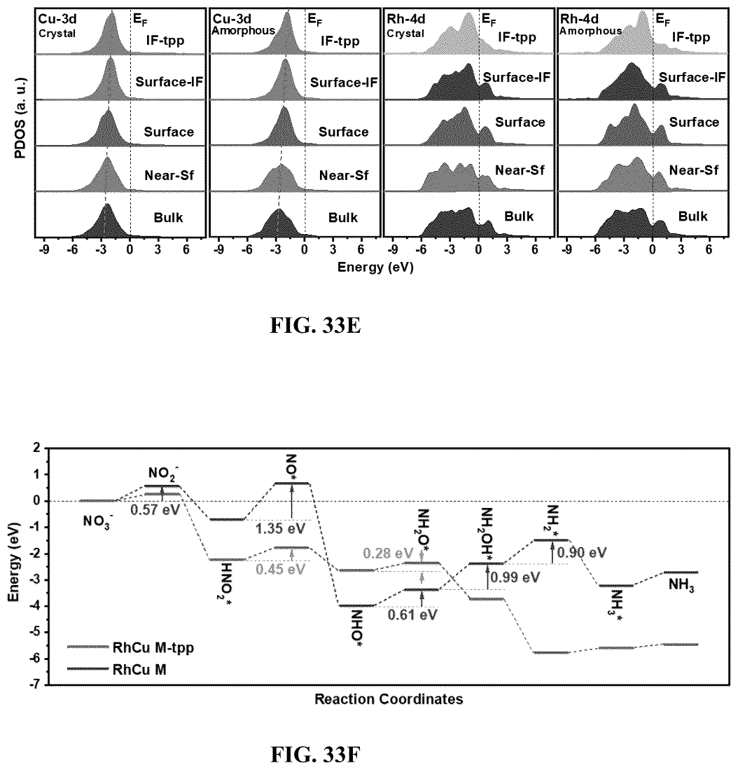

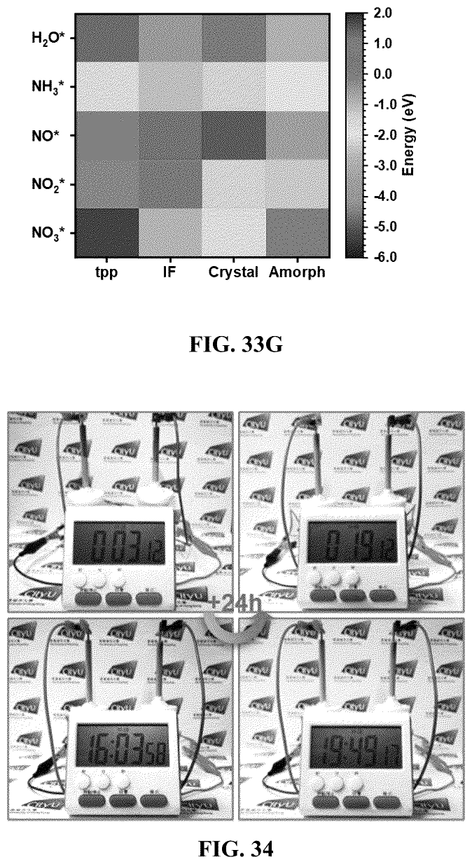

To better understand the electroactivity improvements, DFT calculations were conducted to investigate the electronic modulations induced by the surface tpp molecules. Considering the computational load, a single TPP (Transition Path Sampling) building unit was incorporated at the interface between crystalline and amorphous RhCu. For the electronic distributions near the Fermi level (EF), it was observed that the interfacial region and surface TPP dominated the bonding orbitals of the RhCu M-TPP surface, serving as the main active sites. Compared to the RhCu M, the bonding orbitals became much stronger at the interface between the crystalline and amorphous regions, which supported the increase in active sites for NO₃RR. (FIGS. 33A-33B). The coverage of TPP molecules on the surface activated the electroactivity of the surface regions, providing more accessible active sites. These results indicated that the abundant crystal-amorphous interfaces and surface TPP modifications were significant for ensuring a highly electroactive surface and efficient electron transfer efficiency from catalysts to the adsorbates. The interface remained stable after geometry optimizations, indicating the overall good stability of the catalysts.

To reveal the electronic structures, the projected partial density of states (PDOSs) was demonstrated (FIG. 33C). Cu-3d orbitals located near E_{V}−2.18 eV (Ev=0 eV) with good orbital coupling with Rh-4d orbitals. Meanwhile, Rh-4d orbitals covered the Cu-3d orbitals and crossed the E_{F} with e_{g}-t_{2g} splitting of 2.97 eV to facilitate electron transfer. This electronic structure supplied a highly robust electroactivity of active sites during NO₃RR. The introduction of surface tpp not only enhanced the electron density near E_{F} to accelerate the electron transfer but also offered broad p orbital distributions to improve the adsorption of NO₃⁻ through p-p couplings. Such strong adsorption of NO₃⁻ on surface tpp was further demonstrated by the PDOSs (FIG. 33D). Notably, the downshifting of s,p orbitals of NO₃⁻ was noted, supporting the electron transfer from the RhCu M-tpp to the adsorbates. For the free NO₃⁻, the good overlapping of s,p orbitals with the tpp molecule was observed, especially near E_{V}−6.0 eV to E_{V}−8.0 eV, which induced the stable binding and activation of NO₃⁻ to accelerate the following reduction steps. For the Cu sites in the crystalline RhCu part, the Cu-3d orbitals exhibited a gradual upshifting trend from the bulk to the surface, leading to the improved d-band center and electroactivity.

In particular, it was observed that the introduction of TPP resulted in the upshift of Cu-3d orbitals, consistent with the XPS results showing a slight enlargement of the valence state of Cu sites (FIG. 33E). The electronic structure evolutions of Cu-3d became even stronger in the amorphous part. The bulk Cu-3d showed evidently a lower position than that of the surface Cu sites. However, compared to the crystalline part, the Cu-3d orbitals were located closer to the EF in the amorphous part, indicating that the amorphous part played a significant role in promoting the electroactivity of surface interfacial regions. For the Rh-4d orbitals in the crystalline structures, the e_{g}-t_{2g} splitting was gradually alleviated from the bulk to the surface. After the introduction of tpp, the e_{g}-t_{2g} splitting was significantly reduced with enhanced electron density near E_{F}, leading to faster site-to-site electron transfer in RhCu M-tpp. For the amorphous part, the e_{g}-t_{2g} splitting of Rh-4d orbitals delivered a volcano trend, which increased first at the surface and reduced at the interface sites with tpp. This demonstrated the critical role of surface modification with tpp in facilitating electron transfer on the RhCu M catalyst.

Referring to FIG. 33F, the reaction energy of NO3RR was compared between RhCu M-tpp and RhCu M to underscore the significance of tpp. Notably, the introduction of tpp on the RhCu M catalyst reduced the activation barriers for the conversion of nitrate to NO₂* from 0.57 eV to 0.26 eV. The largest energy barrier was observed at the conversion from HNO₂* to NO* for both RhCu M-tpp and RhCu M. RhCu M demonstrated a continuous uphill trend from NHO* to NH₂*, which largely lowered the electrocatalytic performance. In contrast, RhCu M-tpp only showed one minor barrier of 0.28 eV from NHO* to NH₂O, supporting a highly efficient nitrate reduction. Moreover, the desorption of generated NH₃ displayed an energy barrier of only 0.13 eV on RhCu M-tpp, which was much smaller than that on RhCu M (0.50 eV), offering a fast generation of NH₃.

To reveal the reaction trends of NO₃RR, the adsorption energies of different key intermediates were compared on different sites of RhCu M-tpp, as shown in FIG. 33G and Table 2.

TABLE 2
Adsorption energies of NO₃*, NO₂*, NO*, NH₃*
and H₂O* on the different sites of RhCu M-tpp.

| | E_{ads} | E_{ads} | E_{ads} | E_{ads} | E_{ads} |
|---|---|---|---|---|---|
| | (NO₃*) | (NO₂*) | (NO*) | (NH₃*) | (H₂O*) |
| Sites | (eV) | (eV) | (eV) | (eV) | (eV) |
| tpp | −6.0696 | −0.2722 | −0.1106 | −1.7208 | −4.8153 |
| IF | −0.9494 | 0.2717 | −4.7159 | −2.6066 | −0.5214 |
| Crystal | −2.1002 | −1.4370 | 1.5409 | −1.4526 | 0.5720 |
| Amorph | 0.0529 | −2.4441 | −0.6107 | −1.9807 | −0.8712 |

To reveal the reaction trends of NO₃RR, the adsorption energies of different key intermediates were compared on different sites of RhCu M-tpp (FIG. 33G). For the initial reactants, both NO₃⁻ and H₂O were much more preferred to adsorb on the tpp sites, which benefited the activations of nitrate and dissociation of water. In the meantime, the adsorption of NO₂* and NO* became more energetically favored on the amorphous and interfacial sites of the catalyst surface, respectively, indicating the following nitrate reduction process was promoted on the RhCu surface. The adsorption results supported that the nitrate reduction process on RhCu M-tpp was potentially a cascade catalysis, where the surface tpp guaranteed the activation of nitrate while the RhCu played as the active site for the subsequent reduction from NO₂ ⁻ to the final product NH₃.

### Example 11

Application of the Zinc-Nitrate/Ethanol Batteries with RhCu M-Tpp

To demonstrate the potential in consumer electronics, the assembled Zn-nitrate/ethanol battery was utilized to power a commercial digital clock for over 24 h (FIG. 34).

Table 4 showed the comprehensive performance comparison between the as-assembled Zn-nitrate/ethanol (Zn—NO₃RR/EOR) battery and the other representative Zn-based hybridized energy storage systems. The result showed that few Zn-based aqueous batteries reported previously can exhibit such comprehensive performance and multifunctionality than the as-fabricated Zn-nitrate/ethanol battery.

In Table 4, “Functionality” indicates the number of functions (as shown below) possessed by the referred Zn-based aqueous batteries: (A) Electricity supply, (B) Electrosynthesis of NH3, (C) Electrosynthesis of carbon products, (D) Electrosynthesis of organic ammoniates, (E) Carbon neutral, F) Sewage disposal. To clarify, below were the detailed functions and ease of charging for the Zn-based aqueous batteries mentioned:
Zn—NO₃RR/EOR battery [this work]: Functionality-(A)(B)(D)(F)
Zn—NO₃RR battery: Functionality-(A)(B)(F)
Zn—NO₃RR/OER battery: Functionality-(A)(B)(F)
Zn—NO₂RR battery: Functionality-(A)(B)(F)
Zn-Air(O₂) battery: Functionality-(A)
Zn—CO₂/FAO battery: Functionality-(A)(C)(E)
Zn—N₂/OER battery: Functionality-(A)(B)

Besides, “Rechargeability” indicates the ease of charging the referred Zn-based aqueous batteries based on the following criteria: (0) Not rechargeable, (1) Optimal discharge-charge overpotential gap (OOP)>2 V, (2) 1.5 V<OOP<2 V, (3) 1 V<OOP<1.5 V, (4) 0.5 V<OOP<1 V, (5) OOP<0.5 V.

TABLE 4

| | Working | | | | | |
|---|---|---|---|---|---|---|
| | potential | Energy | Power | | | |
| Battery | (V vs. | density (Wh | density | Lifespan | Functionality | Rechargeability |
| category | Zn²⁺/Zn) | kg⁻¹_{Zn}) | (W kg⁻¹_{cat}) | (cycles) | (N) | (N) |
| Zn—NO₃RR/EOR | 1.3 | 650.2 | 2.68 | 400 | 4 | 4 |
| (This work) | | | | | | |
| Zn—NO₃RR | 0.5 | N/A | 0.087 | N/A | 3 | 0 |
| Zn—NO₃RR/OER | 1.1 | N/A | 1.625 | 13 | 3 | 1 |
| Zn—NO₂RR | 0.72 | 512.1 | 12.06 | N/A | 3 | 0 |
| Zn—Air(O₂) | 1 | 684 | N/A | 320 | 1 | 4 |
| Zn—CO₂/FAO | 0.75 | N/A | 4.28 | 180 | 3 | 5 |
| Zn—N₂/OER | 0.82 | N/A | 3.1 | N/A | 2 | 2 |

“N/A” represents no data available from the literatures.

The foregoing description of the present invention has been provided for the purposes of illustration and description. It is not intended to be exhaustive or to limit the invention to the precise forms disclosed. Many modifications and variations will be apparent to the practitioner skilled in the art.

The embodiments were chosen and described in order to best explain the principles of the invention and its practical application, thereby enabling others skilled in the art to understand the invention for various embodiments and with various modifications that are suited to the particular use contemplated.

### INDUSTRIAL APPLICABILITY

The present invention provides an efficient bifunctional catalyst of holey heterophase RhCu M-tpp for low-overpotential NH₃ electrosynthesis and ethanol oxidation. There exists a molecule-metal relay catalytic mechanism in nitrate reduction over RhCu M-tpp, which significantly facilitates reaction kinetics and selectivity via a low energy barrier pathway.

This invention not only underscores the importance of molecule-metal relay catalysis for efficient NH₃ electrosynthesis in NO₃RR but also presents a multifunctional battery prototype to demonstrate the advantages of metal-based hybrid electrochemical systems for high-performance and sustainable energy storage and conversion. Zn-nitrate batteries represent an ideal electrochemical resource candidate possessing these advantageous properties, which hold great potential in the realms of clean energy, catalysis, fine chemical engineering, electronics, and more. The primary potential markets for this invention include power supplies for electric transportation tools and stationary energy storage equipment.

### Definition

Throughout this specification, unless the context requires otherwise, the word “comprise” or variations such as “comprises” or “comprising”, will be understood to imply the inclusion of a stated integer or group of integers but not the exclusion of any other integer or group of integers. It is also noted that in this disclosure and particularly in the claims and/or paragraphs, terms such as “comprises”, “comprised”, “comprising” and the like can have the meaning attributed to it in U.S. Patent law; e.g., they allow for elements not explicitly recited, but exclude elements that are found in the prior art or that affect a basic or novel characteristic of the present invention.

Furthermore, throughout the specification and claims, unless the context requires otherwise, the word “include” or variations such as “includes” or “including”, will be understood to imply the inclusion of a stated integer or group of integers but not the exclusion of any other integer or group of integers.

As used herein and not otherwise defined, the terms “substantially,” “substantial,” “approximately” and “about” are used to describe and account for small variations. When used in conjunction with an event or circumstance, the terms can encompass instances in which the event or circumstance occurs precisely as well as instances in which the event or circumstance occurs to a close approximation. For example, when used in conjunction with a numerical value, the terms can encompass a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%.

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately.

“RhCu metallenes” refers to the metal compounds composed of rhodium (Rh) and copper (Cu). In the present invention, they are amorphous/crystalline RhCu metal compounds formed by the slow co-reduction of Rh and Cu precursors in a amine compound such as oleylamine.

“Tetraphenylporphyrin (TPP)” is an organic compound belonging to the class of porphyrin compounds. It consists of four phenyl groups connected to each other, forming a planar ring with four nitrogen atoms at the center. TPP finds wide applications in biochemistry and organic synthesis, particularly as a photosensitizer, catalyst, and molecular recognition tool.

The term “Reversible Hydrogen Electrode (RHE)” is a reference electrode commonly used in electrochemistry. It is based on hydrogen gas and, under standard conditions (1 atm H2, 25° C.), its potential is defined as 0 V. The RHE provides a stable potential reference for measuring the potential of other electrodes.

The term “bipolar membrane” is a specialized membrane commonly used in electrochemical applications. It can split water into hydrogen and oxygen while simultaneously separating hydrogen ions and hydroxide ions.

Other definitions for selected terms used herein may be found within the detailed description of the present invention and apply throughout. Unless otherwise defined, all other technical terms used herein have the same meaning as commonly understood to one of ordinary skill in the art to which the present invention belongs.

### REFERENCES: THE DISCLOSURES OF THE FOLLOWING REFERENCES ARE INCORPORATED BY REFERENCE

1. Y. Guo et al., Pd doping-weakened intermediate adsorption to promote electrocatalytic nitrate reduction on TiO₂ nanoarrays for ammonia production and energy supply with zinc-nitrate batteries. Energy Environ. Sci. 14, 3938-3944 (2021).
2. W. Sun et al., A rechargeable zinc-air battery based on zinc peroxide chemistry. Science 371, 46-51 (2021).
3. Guo, Ying, et al. “Pd doping-weakened intermediate adsorption to promote electrocatalytic nitrate reduction on TiO₂ nanoarrays for ammonia production and energy supply with zinc-nitrate batteries.” Energy & Environmental Science 14.7 (2021): 3938-3944.
4. W. He et al., Splicing the active phases of copper/cobalt-based catalysts achieves high-rate tandem electroreduction of nitrate to ammonia. Nat. Commun. 13, 1129 (2022).
5. Y. Wang, W. Zhou, R. Jia, Y. Yu, B. Zhang, Unveiling the activity origin of a copper-based electrocatalyst for selective nitrate reduction to ammonia. Angew. Chem. Int. Ed. 59, 5350-5354 (2020).
6. Y. Q. Kang et al., Selective etching induced synthesis of hollow Rh nanospheres electrocatalyst for alcohol oxidation reactions. Small 14, 1801239 (2018).

What is claimed is:

1. A rechargeable zinc-nitrate/ethanol battery, comprising:
a cathode comprising a conductive substrate coated with one or more copper-based catalysts having a heterophase structure;
an anode;
a separator placed between the cathode and the anode;
an anolyte on the anode side; and
a catholyte on the cathode side,
wherein the rechargeable zinc-nitrate/ethanol battery demonstrates an energy density of at least 110,000 Wh kg⁻¹_{cat}, a power density of at least 1.5 mW cm⁻², long-term cycling stability of approximately 400 cycles.

2. The rechargeable zinc-nitrate/ethanol battery of claim 1, wherein the one or more copper-based catalysts comprise tetraphenylporphyrin modified rhodium-copper alloy metallene, with a 2θ value of 41-42°.

3. The rechargeable zinc-nitrate/ethanol battery of claim 2, wherein the tetraphenylporphyrin modified rhodium-copper alloy metallene comprises 60-85 wt % of Rh and 15-40 wt % of Cu.

4. The rechargeable zinc-nitrate/ethanol battery of claim 2, wherein the tetraphenylporphyrin modified rhodium-copper alloy metallene exhibits a micrometer-sized self-assembly network, with interconnected two-dimensional flexible nanosheets.

5. The rechargeable zinc-nitrate/ethanol battery of claim 2, wherein a conversion of NO₃⁻ to NH₃ occurs at a low overpotential less than −0.1V, the NO₃⁻ is firstly adsorbed and subsequently reduced to NO₂ on tetraphenylporphyrin, and then NO₂ diffuses to Cu sites for a subsequent hydrogenation process assisted by surrounding rhodium atoms toward NH₃ production.

6. The rechargeable zinc-nitrate/ethanol battery of claim 5, wherein the tetraphenylporphyrin modified rhodium-copper alloy metallene has a NH₃ yield rate increasing with a decreasing potential, nearly 6 times higher than that of an unmodified rhodium-copper alloy metallene.

7. The rechargeable zinc-nitrate/ethanol battery of claim 2, wherein the tetraphenylporphyrin modified rhodium-copper alloy metallene exhibits two ethanol oxidation peaks at 0.8 and 0.4 V compared to a reversible hydrogen electrode in an alkaline solution with alcohol comprising EtOH, MeOH, or ethylene glycol.

8. The rechargeable zinc-nitrate/ethanol battery of claim 2, wherein the tetraphenylporphyrin modified rhodium-copper alloy metallene achieves an ammonia Faradaic efficiency (FE) of at least 70% with a potential above −0.4 V.

9. The rechargeable zinc-nitrate/ethanol battery of claim 1, wherein the zinc-nitrate/ethanol battery demonstrates a decrease in charge plateau of approximately 130 mV at 0.1 mA cm⁻² and maintains normal function for at least 40 hours.

10. The rechargeable zinc-nitrate/ethanol battery of claim 1, wherein the conductive substrate comprises conductive carbon cloth or glassy carbon electrode.

11. The rechargeable zinc-nitrate/ethanol battery of claim 1, wherein the anode comprises zinc plate.

12. The rechargeable zinc-nitrate/ethanol battery of claim 1, wherein the separator comprises bipolar membrane.

13. The rechargeable zinc-nitrate/ethanol battery of claim 1, wherein the anolyte comprises 1 M KOH aqueous solution with 0.02 M Zn(CH₃COO)₂, and the catholyte comprises a mixture of 0.5 M Na₂SO₄/3000 ppm NO₃⁻ solution and 1 M ethanol.

14. The rechargeable zinc-nitrate/ethanol battery of claim 1, wherein the heterophase structure comprises a crystalline domain and an amorphous domain.

15. A method for synthesizing a heterophase tetraphenylporphyrin modified rhodium-copper alloy metallene, comprising
co-reducing rhodium (Rh) and copper (Cu) precursors in an oleylamine solution to obtain RhCu metallenes, wherein the Rh and Cu precursors have a feeding ratio of 8:1;
adding at least one reductant and at least one surfactant for surface modifying the RhCu metallenes;
heating the RhCu metallenes in an oil bath at 160° C. for 12 hours to obtain modified RhCu metallenes; and
subjecting the modified RhCu metallenes to ligand exchange in chloroform dissolved with tetraphenylporphyrin and centrifugating at 10,000 rpm for 5 minutes to obtain the heterophase tetraphenylporphyrin modified rhodium-copper alloy metallene,
wherein the heterophase tetraphenylporphyrin modified rhodium-copper alloy metallene has a thickness in a range of 0.01 nm to 1 nm.

16. The method of claim 15, wherein the tetraphenylporphyrin modified rhodium-copper alloy metallene comprises 60-85 wt % of Rh and 15-40 wt % of Cu, and the Rh and Cu have an elemental ratio of 4:1.

17. The method of claim 15, wherein the at least one reductant comprises 1, 2-butylene glycol, and the at least one surfactant comprises potassium iodide.

18. The method of claim 15, wherein the RhCu M and the tetraphenylporphyrin has a ratio of 95:5.

19. The method of claim 15, the heating is conducted at a reaction temperature ranging from 155 to 180° C.

20. The method of claim 15, wherein the tetraphenylporphyrin has a concentration in a range of 5 to 100 mM.
